(19) United States
(12) Patent Application Publication
(10) Pub. No.: US 2026/0119239 A1
(43) Pub. Date: Apr. 30, 2026

(54) ARTIFICIAL INTELLIGENCE-BASED DIGITAL COWORKER

(71) Applicant: Aimyable, Inc., Dover, DE (US)

(72) Inventors: Kenneth Lee Virgin, Aliso Viejo, CA (US); Apoorv Agarwal, Tempe, AZ (US); Trevin Pratt Avery, Happy Valley, OR (US)

(21) Appl. No.: 19/369,050

(22) Filed: Oct. 24, 2025

Related U.S. Application Data
(60) Provisional application No. 63/711,391, filed on Oct. 24, 2024.

(51) Int. Cl. G06F 9/48; G06F 9/451; G06F 11/07

(52) U.S. Cl. CPC G06F 9/4881; G06F 9/451; G06F 11/0772

(57) ABSTRACT

A system implementing artificial intelligence is disclosed. A system may include a memory and processor. The processors may be configured to retrieve, from the memory, information associated with a process step, the information comprising one or more artifacts associated with accomplishing the process step. The processors may be configured to, using one or more machine learning models, generate structured instructions based on the one or more artifacts, the structured instructions comprising computer-executable instructions configured to cause one or more input operations to occur on a workstation computing device. The processors may be configured to cause the workstation computing device to execute the structured instructions.

### CROSS-REFERENCE TO RELATED APPLICATIONS

This application claims benefit of U.S. Provisional Patent Application No. 63/711391, filed Oct. 24, 2024, and titled “ARTIFICIAL INTELLIGENCE-BASED DIGITAL WORKER.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57.

### BACKGROUND

Computer software applications are often used in business and personal applications to accomplish projects or tasks. Doing so often requires navigation through and interaction with many different applications, user interfaces, and information sources. Automating the projects or tasks can face difficulties as human intervention is often required mid task, such as to enter information, interact with UI elements, navigate to different pages or applications, and/or perform other tasks.

### SUMMARY

The systems, methods, and devices of this disclosure each have several innovative aspects, no single one of which is solely responsible for all of the desirable attributes disclosed herein.

In some aspects, the techniques described herein relate to a system for executing automated tasks, the system implementing one or more artificial intelligence models and including: a memory; and one or more processors configured to: retrieve, from the memory, information associated with a process step, the information including one or more artifacts associated with accomplishing the process step; using one or more machine learning models, generate structured instructions based on the one or more artifacts, the structured instructions including computer-executable instructions configured to cause one or more input operations to occur on a workstation computing device; and cause the workstation computing device to execute the structured instructions.

In some aspects, the techniques described herein relate to a system, wherein the one or more artifacts include a captured screenshot from the workstation computing device, and wherein to generate the structure instructions, the one or more processors are configured to: detect, using the one or more machine learning models, at least one user interface element to interact with in accomplishing the process step;.

In some aspects, the techniques described herein relate to a system, wherein at least one of the one or more input operations includes an interaction with the at least one user interface element.

In some aspects, the techniques described herein relate to a system, wherein the one or more processors are further configured to: receive a captured screenshot from the workstation computing device; and verify, using the one or more machine learning models, compatibility of the captured screenshot with the structured instructions.

In some aspects, the techniques described herein relate to a system, wherein the one or more processors are further configured to: determine one or more failures occur on the workstation computing device in accomplishing the process step; and cause the workstation computing device to re-execute the structured instructions.

In some aspects, the techniques described herein relate to a system, wherein the one or more processors are further configured to: determine one or more failures occur on the workstation computing device in accomplishing the process step; and perform at least one of: flagging the process step for review, or presenting the process step to a user computing device and receiving one or more corrections to the one or more input operations.

In some aspects, the techniques described herein relate to a system, wherein the one or more processors are further configured to store the generated structured instructions in the information associated with the process step.

In some aspects, the techniques described herein relate to a system, wherein the one or more processors are further configured to: after executing the computer-executable instructions, retrieve the information associated with the process step from the memory; and cause the workstation computing device to execute the structured instructions stored in the information associated with the process step.

In some aspects, the techniques described herein relate to a system, wherein the one or more processors are further configured to: retrieve, from the memory, information associated with a second process step, the information including a second one or more artifacts, the second one or more artifacts associated with accomplishing the second process step; using the one or more machine learning models, generate second structured instructions based on the second one or more artifacts, the second structured instructions including second computer-executable instructions configured to cause a second one or more input operations to occur on the workstation computing device; and cause the workstation computing device to execute the second structured instructions.

In some aspects, the techniques described herein relate to a system, wherein the one or more input operations includes a mouse or keyboard input on the workstation computing device.

In some aspects, the techniques described herein relate to a system for executing automated tasks, the system implementing one or more artificial intelligence models and including: a memory; and one or more processors configured to: retrieve, from the memory, step-by-step instructions for performing a task, the step-by-step instructions including one or more process steps in the task; and for each of the one or more process steps: retrieve one or more artifacts associated with accomplishing the process step; using one or more machine learning models, generate structured instructions based on the one or more artifacts, the structured instructions including computer-executable instructions configured to cause one or more input operations to occur on a workstation computing device; and cause the workstation computing device to execute the structured instructions.

In some aspects, the techniques described herein relate to a system, wherein the one or more processors are further configured to: receive, from a user computing device, a per step strategy for each of the one or more processes steps; and for each of the one or more process steps, generate the structured instructions based on the per step strategy associated with a current process step.

In some aspects, the techniques described herein relate to a system, wherein the step-by-step instructions include one or more operational parameters configured to provide the one or more machine learning models context associated the performance of the task.

In some aspects, the techniques described herein relate to a system, wherein the operational parameters include at least one of glossary to use to perform the task, workflow rules, or exception handling procedures.

In some aspects, the techniques described herein relate to a system, wherein the one or more processors are further configured to: present, on a user interface, at least one of: the one or more process steps in the task; the one or more artifacts associated with accomplishing one of the one or more process steps; or the one or more input operations associated with one of the one or more process steps; receive, via the user interface, one or more user inputs providing feedback; and updating the one or more process steps.

In some aspects, the techniques described herein relate to a computer-implemented method for executing automated tasks using one or more artificial intelligence models, the method including: retrieving, from a memory, information associated with a process step, the information including one or more artifacts associated with accomplishing the process step; using one or more machine learning models, generating structured instructions based on the one or more artifacts, the structured instructions including computer-executable instructions configured to cause one or more input operations to occur on a workstation computing device; and causing the workstation computing device to execute the structured instructions.

In some aspects, the techniques described herein relate to a method, wherein the one or more artifacts include a captured screenshot from the workstation computing device, and wherein generating the structure instructions includes: detect, using the one or more machine learning models, at least one user interface element to interact with in accomplishing the process step;.

In some aspects, the techniques described herein relate to a method, wherein at least one of the one or more input operations includes an interaction with the at least one user interface element.

In some aspects, the techniques described herein relate to a method, further including: receiving a captured screenshot from the workstation computing device; and verifying, using the one or more machine learning models, compatibility of the captured screenshot with the structured instructions.

In some aspects, the techniques described herein relate to a method, further including: determining one or more failures occur on the workstation computing device in accomplishing the process step; and causing the workstation computing device to re-execute the structured instructions.

In some aspects, the techniques described herein relate to a method, further including: determining one or more failures occur on the workstation computing device in accomplishing the process step; and at least one of: flagging the process step for review, or presenting the process step to a user computing device and receiving one or more corrections to the one or more input operations.

In some aspects, the techniques described herein relate to a method, further including storing the generated structured instructions in the information associated with the process step.

In some aspects, the techniques described herein relate to a method, further including: after executing the computer-executable instructions, retrieving the information associated with the process step from the memory; and causing the workstation computing device to execute the structured instructions stored in the information associated with the process step.

In some aspects, the techniques described herein relate to a method, further including: retrieving, from the memory, information associated with a second process step, the information including a second one or more artifacts, the second one or more artifacts associated with accomplishing the second process step; using the one or more machine learning models, generating second structured instructions based on the second one or more artifacts, the second structured instructions including second computer-executable instructions configured to cause a second one or more input operations to occur on the workstation computing device; and causing the workstation computing device to execute the second structured instructions.

In some aspects, the techniques described herein relate to a method, wherein the one or more input operations includes a mouse or keyboard input on the workstation computing device.

### BRIEF DESCRIPTION OF THE DRAWINGS

Throughout the drawings, reference numbers are re-used to indicate correspondence between referenced elements. The drawings are provided to illustrate embodiments of the subject matter described herein and not to limit the scope thereof.

FIG. 1A illustrates an embodiment of a computing environment for implementing an artificial intelligence (AI) digital worker.

FIG. 1B illustrates an embodiment of the AI digital worker.

FIG. 2 illustrates an example implementation of an AI digital worker according to an embodiment.

FIG. 3 illustrates another example implementation of an AI digital worker according to an embodiment.

FIG. 4 illustrates a flow diagram of a routine for performing a job or task, according to various embodiments.

FIG. 5 illustrates an embodiment of computing device according to the present disclosure.

### DETAILED DESCRIPTION

### Overview

Described herein are systems and methods for automating and streamlining various processes within an organization. Embodiments of the disclosure relate to artificial intelligence-based systems and methods for automating processes within organizations (referred to generally herein as an “AI digital worker”). For illustrative purposes, various embodiments of the systems and methods are described with respect to automating accounts payable processes. However, it can be appreciated that the various systems and methods can be applied otherwise without departing from the disclosure. According to various aspects, the systems and methods disclosed herein can assist in the efficient management of invoice processing, supplier communications, and payment exemption resolutions. The systems and methods disclosed herein can reduce and/or eliminate manual oversight of many of these processes, increasing overall efficiency and reducing overall error that can occur in the various processes described herein.

Projects within an organization, such as payment processing, can often involve multiple users, software applications, and information sources. Users may message or email each other regarding a project and attend meetings (e.g., virtual meetings) to discuss the project and then each work to produce different work product for the project. Automation of tasks in a project can be difficult. For example, it can be difficult to automate a process that requires information from messages, emails, meetings, and/or other contexts. Additionally, software applications required for the task may prompt repeated user input, interrupting automation processes.

The systems and methods described herein can automate and assist in various aspects of implementing a project or task. The systems and methods can, for example, automate or assist in the ingestion of information, the creation of projects or tasks, and the execution of the projects or tasks. Further the systems and methods can provide various graphical user interfaces (GUIs) that allow users to initiate projects or tasks, make inquiries to the system, correct errors in the implementation of the task, and view results. In various embodiments, a user may interact with the system using plain language (typed or spoken) and receive responses in plain language. Embodiments of the system include a rendered avatar that can provide responses in plain language.

Various aspects of the systems and methods disclosed herein are described below.

### Invoice Data Extraction & Processing

According to various implementations, the system can include and/or follow instructions to find invoices ready to be processed. The system can extract critical data from those invoices without relying on external tools (e.g., external Optical Character Recognition (OCR) tools), utilizing an internal process that reads and organizes structured invoice data, such as amounts, purchase orders, and payment terms.

The system can extract and organize structured data from diverse business documents such as invoices, purchase orders, receipts, or contracts. Unlike traditional OCR pipelines, the system converts documents into structured representations (e.g., JavaScript Object Notation (JSON) and/or other structured representations) for efficient reuse (e.g., for reuse in large language model (LLM) prompts), thereby avoiding repeated parsing of bulky files and reducing latency and computational overhead.

### Exception Management

According to various implementations, the system can identify discrepancies in approvals and purchase order (PO) matching. The system can autonomously create resolution paths to resolve these issues. The system can follow pre-defined rules (e.g., organizational specific rules) and escalates issues only when an action deviates from established policies.

For example, the system can detect discrepancies in workflows, such as mismatches between documents or deviations from approval policies. The system can generate resolution paths according to stored rules and determine whether to resolve issues directly, request corrections, or escalate them to authorized users.

### Supplier Communication

According to various implementations, the system can autonomously use the create and use resolution paths to resolve discrepancies and disputes. For example, the system can generate and send emails to suppliers and process received responses to resolve these issues. The resolution path may also include internal users, not just suppliers.

The system can communicate with external parties (e.g., suppliers) and internal users (e.g., managers) to resolve workflow exceptions. Communications may occur over email, chat, meeting platforms, and/or other suitable communication tools and include identifiers (e.g., Inquiry IDs or similar identifiers) linking conversations to the correct workflow case.

### RPA Control

According to various implementations, the system can direct a Robotic Process Automation system (referred to herein as a “RPA”) that uses a combination of screenprints, graphical user interface (GUI) element identifiers, and custom artificial intelligence models. The RPA can translate responses from an LLM into workstation actions such as mouse movements, keyboard entries, and/or other simulated user input actions (e.g., from a user input library). This can allow the system to execute actions in both a local operating system and web-based applications (e.g., cross-platform automation), handling tasks such as data entry, navigation, and report generation. The system can record RPA actions for future use. For example, the system can record the action paths used by the RPA. If any of these recorded action paths fail (e.g., due to interface changes), the system may recalculate a new path and store the change.

### Custom Instance Per Client

According to various implementations, the system can be personalized for each client. For instance, each client can have a personalized version of the system deployed that remembers specific field mappings, workflows, and exception handling processes used by the client. This can allow for seamless integration with diverse platforms (e.g., accounts payable platforms) and client specific rules. For example, each deployment of the system can adapt to the client's environment and remember various client specific aspects, such as field mappings, workflows, glossary terms, and exception-handling processes. In some instances, the system can implement contextual grounding using retrieval-augmented generation (RAG) glossaries allowing for accurate informational interpretation across different enterprise platforms (e.g., Oracle, SAP, Lawson).

### Task Scheduling & Predictive Analytics

According to various implementations, the system can schedule and manage tasks based on conversations between various users (e.g., conversations between an accounts payable manager and other users). For example, the system can schedule and manage tasks based on converted natural-language requests (e.g., by converting the natural-language requests into structured recurrence codes). The system can enforce dependency management, log errors, and provide calendar views with status indicators. The system can provide real-time analytics and predictions to users. For example, about invoice processing efficiency, payment timelines, and supplier performance. The system can also utilize meeting software to participate in team meetings to answer questions, give updates, and further identify tasks to be performed. For example, the system can participate in meetings by ingesting closed-caption feeds, answering questions, providing updates, and detecting new tasks requested by users in real time.

### Overview of Computing Environment

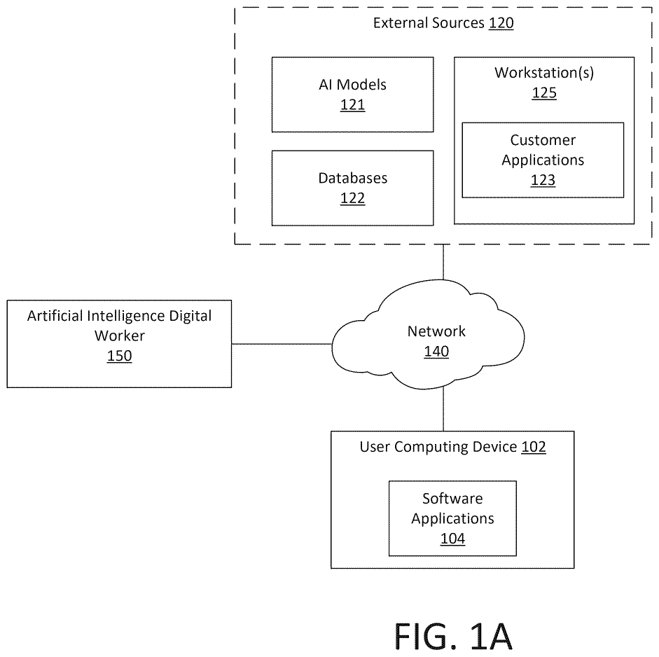

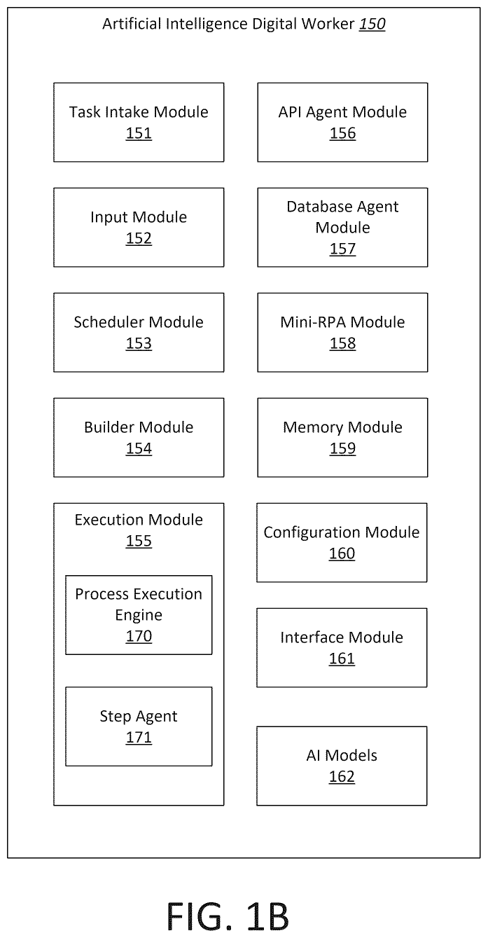

FIG. 1A illustrates an embodiment of a computing environment for implementing an AI digital worker 150. The computing environment can include a network 140, an AI digital worker 150, one or more user computing devices 102, and external sources 120. The AI digital worker 150 may communicate via the network 140 with the user computing device 102 and the external sources 120. Although only one network 140 is illustrated, multiple distinct and/or distributed networks 140 may exist. The network 140 can include any type of communication network. For example, the network 140 can include one or more of a wide area network (WAN), a local area network (LAN), a cellular network, an ad hoc network, a satellite network, a wired network, a wireless network, and so forth. In some embodiments, the network 140 can include the Internet.

### User Computing Device 102

FIG. 1A illustrates an exemplary user computing device 102 associated with one or more users. A user computing device 102 may include hardware and software components for establishing communications over a communication network 140. For example, user computing device 102 may be equipped with networking equipment and network software applications (for example, a web browser) that facilitate communications via one or more networks (for example, the Internet or an intranet). The user computing device 102 may have varied local computing resources such as central processing units (CPU) and architectures, memory, mass storage, graphics processing units (GPU), communication network availability and bandwidth, and so forth. Further, the user computing device 102 may include any type of computing system. For example, the user computing device 102 may include any type of computing device(s), such as desktops, laptops, video game platforms, television set-top boxes, televisions (for example, Internet TVs), network-enabled kiosks, car-console devices, computerized appliances, wearable devices (for example, smart watches and glasses with computing functionality), and wireless mobile devices (for example, smart phones, PDAs, tablets, or the like), to name a few. The specific hardware and software components of the user computing device 102, are referred to generally as computing resources.

The user computing device 102 can communicate with AI digital worker 150, via the network 140, to interact with the AI digital worker 150. The user computing device 102 can include various software applications 104 used in interacting with the AI digital worker 150. The software applications 104 can include GUIs displaying information from the AI digital worker 150 and/or the external sources 120. In various implementations, a user may interact with the AI digital worker 150 via the software applications 104. For example, a user may input information (e.g., text) to the software applications 104 and receive responses from the AI digital worker 150. The software applications 104 can also include other computer software such as web browsers, operating systems, and/or other suitable software, used in performing various tasks associated with projects. For example, a user may use the software applications 104 to email or message clients and coworkers, attend virtual meetings, create and edit artifacts and documents, and/or perform other functions. In some implementations, the software applications 104 can include applications that can capture information displayed to a user via the user computing device 102 (e.g., capture what is displayed to the user).

A user of the user computing device 102 may interact with the AI digital worker 150 using the software applications 104 in multiple ways. For example, in some instances, the user may interact with the AI digital worker 150 through interacting with an application (e.g., a software as a service (SaaS)) application, such as by entering data fields or uploading documents. In other instances, the user may interact with the AI digital worker 150 using plain language, such as in a chat box conversation or conversation with a rendered virtual model.

### AI Digital Worker 150

In various implementations, the AI digital worker 150 may interact with the user computing device 102 and the external sources 120 to create and execute various tasks. The AI digital worker 150 can be implemented on one or more computer servers, as a cloud service, locally on a computing device, or otherwise implemented. The AI digital worker 150 can receive input from the user computing device 102 and make various calls to the external sources 120 to create projects or tasks, create steps for accomplishing a project or task, implement the steps, and log and display results to the user computing device 102.

The AI digital worker 150 can perform various tasks, a summary of some of the tasks is as follows.

Autonomous Exception Resolution with Communication Loops. The AI digital worker 150 can identify discrepancies in workflows such as approval routing errors or mismatched documents. For example, in one embodiment, the AI digital worker 150 can identify invoice-to-purchase order mismatches. Based on predefined rules, the AI digital worker 150 can generate responses to external parties or internal users, interpret replies without human intervention, and either update records or escalate the issue. This automated closed-loop resolution reduces human intervention while maintaining compliance with organizational policy.

Customizable GUI Element Detection for RPA. The AI digital worker 150 can dynamically identify GUI elements using AI-based models, enabling navigation and interaction across both desktop and web applications without reliance on pre-programmed selectors. In one embodiment, this eliminates the need for brittle CSS/XPath selectors common in traditional RPA. This adaptability can ensure continued operation when user interfaces change, providing a resilient automation method not dependent on static identifiers.

Hybrid RPA Controlled by AI. The AI digital worker 150 integrates AI decision-making with an RPA engine that can combine screenprint analysis, GUI element detection, and simulated input libraries (e.g., keystrokes, mouse movements). In one embodiment, this hybrid approach allows execution across both Windows and web-based applications. By dynamically adapting instead of relying on brittle pre-scripted RPA routines, the AI digital worker 150 can maintain operability in environments where interfaces evolve frequently.

Client-specific Instance Tailoring With Memory. Each Deployment of the AI digital worker 150 can adapt to client requirements by learning and remembering field mappings, workflow rules, glossary terms, and exception-handling processes. In one embodiment, contextual grounding is enhanced with retrieval-augmented glossaries specific to enterprise platforms such as Oracle, SAP, or Lawson. Over time, the coworker builds a contextual memory unique to each client (e.g., by storing unique operational parameters in memory specific to the various field mappings, workflow rules, glossary terms, and exception-handling processes associated with the client), enabling seamless customization without explicit reprogramming.

Location Memory and Mapping Replay. The AI digital worker 150 can store navigation and action steps as location memories for rapid reuse without invoking a large language model. In one embodiment, this reduces execution time by replaying prior navigation in seconds rather than recalculating through AI each time. If downstream validation fails, the AI digital worker 150 can invalidate the stored memories and re-executes the workflow, providing both efficiency and accuracy.

Assist Mode for User-guided GUI Mapping. When GUI detection is incomplete, the AI digital worker 150 can generate an illustrated representation of the application interface. In one embodiment, the AI digital worker 150 provides a simplified overlay of detected elements, allowing users to correct or add mappings through graphical clicks, textual input, or voice commands. These corrections are then stored for future executions. This “assist mode” enables non-technical users to refine GUI mappings without developer intervention, improving adaptability compared to traditional RPA scripting tools.

Autonomous Workflow Learning and Instruction Storage. The AI digital worker 150 can autonomously generate GUI element identifiers, store them for reuse, and incorporate user-provided corrections into future executions. In one embodiment, the AI digital worker 150 builds an evolving library of validated instructions specific to client applications, reducing the need for repetitive training or reconfiguration. This capability can support continuous learning and improvement, distinguishing the system from static RPA frameworks that require full reprogramming when workflows evolve.

Dynamic Instruction Generation Across Multi-Platform Environments. The AI digital worker 150 can generate instructions in real time for interacting with applications across multiple environments, including both desktop and web-based systems. In one embodiment, the AI digital worker 150 analyzes GUI elements dynamically to create execution instructions without pre-scripted automation routines. This adaptive instruction generation supports resilient cross-platform task execution, a capability not achievable with conventional single-environment RPA approaches.

Workflow Exception Memory and Recall. The AI digital worker 150 can store exceptions, workflow changes, and custom instructions (e.g., as operational parameters for the AI digital worker 150) in memory for later recall. In one embodiment, this allows the AI digital worker 150 to recognize recurring exception scenarios, apply previously successful resolution strategies, and adapt to evolving business rules without explicit reprogramming.

Integration with AI Video and Audio Avatars. The AI digital worker 150 can communicate through video avatars and synchronized audio to provide human-like interaction. In one embodiment, the coworker joins video meetings via integrations with platforms such as Teams or Zoom, ingests closed-caption feeds as structured input, and provides updates or executes tasks in real time. This capability enables the coworker to act as a participant in enterprise collaboration environments, distinguishing it from chatbots or standalone automation systems.

Client/Server Processing Toggle and Debug Mode. The AI digital worker 150 can include a processing toggle that allows tasks to execute on either the client workstation (e.g., using the various customer applications 123) or a server environment. In one embodiment, the AI digital worker 150 dynamically switches execution mid-process without loss of state, enabling performance tuning and security-sensitive deployments. Dual execution modes may be run in parallel to compare results, thereby isolating whether failures originate locally or in the cloud.

Learning From Communication Patterns. The AI digital worker 150 can analyze communication patterns from external parties (e.g., suppliers, customers) and adapt future strategies based on observed behavior. In one embodiment, the AI digital worker 150 tracks response latency, terminology, and resolution outcomes to anticipate future queries or optimize reply timing. This feedback-driven improvement loop enhances communication efficiency, differentiating the system from conventional automation tools that treat each interaction in isolation.

Multi-Modal Input Integration. The AI digital worker 150 accepts diverse inputs, including screenprints, chat text, voice commands, and file uploads, and converts them into structured instructions for execution. In one embodiment, the AI digital worker 150 fuses multiple modalities to validate intent (e.g., confirming a voice command with a screenprint context). This capability enables both automated data extraction and human-driven exception handling.

Schema-Locked Instruction Validation. All generated instructions can be validated against both schema constraints and action-specific keywords (e.g., “click,” “enter”) before execution. In one embodiment, this schema-locked validation is paired with a canary check to confirm that natural language intent aligns with the structured command. This dual validation prevents malformed or unsafe commands from being executed, reducing the risk of system errors or unauthorized operations.

Document Pre-Processing. The AI digital worker 150 can convert business documents such as invoices, purchase orders, receipts, and contracts into structured formats (e.g., JSON structures) and store them for re-use. In one embodiment, the AI digital worker 150 ingests a PDF only once, converts it into JSON, and reuses the structured representation for downstream tasks such as matching, reconciliation, or analytics. This reduces repeated OCR and parsing, lowering latency and compute costs relative to conventional automation pipelines.

Community-Trained Best Practices Model. The AI digital worker 150 can aggregate anonymized process data across multiple clients to generate a distilled best-practices model. In one embodiment, this model is used to recommend optimized workflows to new clients while still permitting local customization and overrides. By leveraging collective intelligence, the coworker can guide clients toward industry-standard practices.

The AI digital worker 150 is described in further detail with respect to FIG. 1B below.

### External Sources 120

The AI digital worker 150 and/or the user computing device 102 may interact with one or more external sources 120. The external sources 120 can include one or more AI models 121, one or more databases 122, and various customer applications 123.

The AI models 121 can be called to perform one or more options described herein. In various embodiments, the AI models 121 include various machine-learning models such as language models, large language models (LLM), and/or other suitable machine-learning models. The AI models 121 can aid in various operations of the AI digital worker 150 described herein, including, ingesting information, providing responses, and building step specific instructions.

The customer applications 123 can include various software applications used to accomplish a project or task. The AI digital worker 150 may control operation of the various customer applications 123 directly (e.g., via keystrokes and mouse clicks), in the step-by-step executions described herein. In various implementations, some of the external sources 120 may be implemented on one or more dedicated workstations 125 in communication with the AI digital worker 150. The dedicated workstation 125 can, for example, execute the various customer applications 123, receive controls and/or instructions from the AI digital worker 150 to perform operations within the customer applications 123 (e.g., click user interface elements, enter text, etc.). The AI digital worker 150 can confirm the actions are performed on the dedication workstation 125 (e.g., by verifying the expected change to the customer applications 123 occurs). The dedicated workstation 125 may have one or more applications installed that are configured to interface with the AI digital worker 150. For example, the dedicated workstation 125 may have suitable applications installed that interface with the AI digital worker 150 (e.g., using the RPA module 158) and cause direct input (e.g., keystrokes, cursor traversal, and mouse clicks) to be performed on the dedicated workstation 125. The databases 122 can store various information used in processing a project or task. The AI digital worker 150 may read and write to these servers to, for example, retrieve data to be entered in a form. In various embodiments, the databases 122 can store some, or all, of the information described as stored in memory module 159 below.

### Example Aspects of an AI Digital Worker

FIG. 1B illustrates an embodiment of the AI digital worker 150. In the illustrated embodiment the AI digital worker 150 includes a task intake module 151, an input module 152, a scheduler module 153, a builder module 154, an execution module 155, an API agent module 156, a database agent module 157, a RPA module 158, a memory module 159, a configuration module 160, an interface module 161, and one or more AI models 162.

### Task Intake Module 151

According to aspects of the disclosure, the AI digital worker 150 can include a task intake module 151 that can perform persistent, prioritized intake for tasks. For example, in some embodiments the task intake module 151 may provide a queue of tasks that prioritizes immediate jobs/tasks over scheduled/recurring jobs. The AI digital worker 150 may perform the tasks based on the parried intake (e.g., executing them in the order of the queue).

The task intake module 151 can determine tasks using the builder module 154 (e.g., ad hoc/immediate tasks) and the scheduler module 153 (e.g., recurring/dependent tasks) and queue the tasks according to defined priority (e.g., prioritizing tasks based or source, type of task, associated information with the task, and/or other suitable priority factors). The task intake module 151 can include various instructions or rules associated with the priority. Any suitable queue may be used by the task intake module 151 (e.g., a priority-first-in-first-out queue). For example, the task queue may have a first-in priority ordering with any ties broken by timestamp, approval gates, and/or time frame windows. Each task can be associated with various information, such as Inquiry IDs, tenants, project/task IDs, step pointers, priorities, create/earliest-start timestamps, tool hints (e.g., API / RPA / database associated information), step-level memory strategy flags, and/or other information described herein with respect to tasks.

When the AI digital worker 150 begins to execute a task (e.g., by claiming a task from the task queue), the task can be marked, flagged, or otherwise differentiated (e.g., with a visibility timeout). On success a task can be marked as success or failure. Task may be requeued after execution. For example, a failed task may be requeued to be executed again. As another example, a recurring tasks may be requeued to be executed again.

In some implementations, the AI digital worker 150 may include instructions for bounded retries of a task. For example, the AI digital worker 150 may attempt to re-execute a task a set number of times (either in succession or by reentering the task in the queue). In some implementations, the instructions may include an exponential backoff that reduces the priority, or otherwise limits execution, of tasks as the number of failed attempts to execute the tasks increases. The AI digital worker 150 may move a task to a dead-letter list after repeated failed attempts to execute the task, which can be used to facilitate investigation into failed tasks. In some implementations, tasks in the dead-letter list continue to be entered into the queue for execution while pending review (e.g., with a reduced priority).

In some implementations, the AI digital worker 150 may maintain idempotency keys (e.g., based on Inquiry ID and/or step) that limit or reduce execution of a task. The idempotency keys may be used to allow safe replays of a task (e.g., by maintaining consistency of results of the task). The idempotency keys may also suppress duplicates.

The AI digital worker 150 may maintain various tenant tags, project affinity tags, and/or other information associated with a task to help prevent cross-tenant bleed in execution of queued tasks. This can also allow for certain users to be partitioned based on tenant or project.

The AI digital worker may log various aspects of tasks in the queue. For example, the AI digital worker 150 may log enqueueing events associated with the task, executions or claims for the task, any re-executions or queues of the task, placement of the task in a dead-letter list, and/or a completion of the task. The log may be used in display of the information (e.g., in a work-in-progress UI displayed on a user computing device 102 and audited by a user.

### Input Module 152

According to aspects of the disclosure, the AI digital worker 150 can include an input module 152 to ingest information using various techniques. The ingested information can include and/or be tagged with various aspects. The ingested information can be tagged with an Inquiry ID, caller identity, channel metadata, and timestamps, and include information for audit and routing. The AI digital worker 150 may ingest information directly from a user computing device 102. For instance, the user computing device 102 can include one or more GUIs that allow a user to input information, such as a task to be performed, a question, and/or other information, which is ingested by the AI digital worker 150. The GUIs can allow textual input (e.g., using a chat box, uploaded textual files, or other suitable technique). The GUIs can also allow for other input such as audio or visual input. For example, in some instances, the GUIs can include input selections that allow a user to record audio and/or visual input.

In some implementations, a GUI on the user computing device 102 can enable two-way chat and voice/video interaction with the AI digital worker 150. A user may, via the GUI, type instructions, paste content, attach file or screenprints, and/or otherwise enter information. Each message, pasted content, attached file, etc. may receive an Inquiry ID and be stored with any associated transcripts. A user may, via the GUI, enter speech, which can be transcribed and processed as a message. The GUI may also generate text and/or audio (e.g., using text-to-speech) and video and present the text and/or audio and video via the GUI and/or using components of the user computing device 102 (e.g., attached peripherals). In some embodiments an avatar video stream is rendered inline in the GUI and presented to a user. Any attachments or screenprints can be linked to the Inquiry ID. In some implementations, frequently used output from the GUI (e.g., frequently used avatar video segments) may be cached. The cache can include automatic expiry (e.g., if the frequency of use is reduced).

In some instances, the AI digital worker 150 can ingest information from multiple sources and/or directly from software applications implemented on the AI digital worker 150 and/or elsewhere. For example, the AI digital worker 150 may ingest information from client messages or email (e.g., from messages between client employees). In some instances the AI digital worker 150 can interact directly with various server side Application Programming Interfaces (API) to ingest messages, emails, attachments, metadata, and/or other information. The AI digital worker 150 may also access the information directly from a workstation (e.g., a user computing device 102) using the various UI automation techniques described herein. Each message, email, thread, and/or the like can be assigned an Inquiry ID and stored with other identifying information, such as sender identity, channel used to send the information, identifier of an overall thread or chain the message or email is contained in and/or associated with, which can be stored and used for processing and traceability.

The AI digital worker 150 may ingest information from an online meeting (e.g., directly from the audio/visual information of the meeting and/or from a transcription of the meeting). In some instances, the AI digital worker 150 may use closed-captioning to and ingest a caption feed associated with a meeting as structured text. This may include various additional features such as speaker identification, attributed utterances to participants, detection when the AI digital worker 150 is directly invoked or addressed, and/or when specific phrases (e.g., invocation phrases) are used. Detected instructions can be assigned an Inquiry ID and processed (e.g., routed for scheduling or execution). The Inquiry ID can also be associated with other information, such as meeting IDs, attendees, and timestamps, and logged and stored in memory (e.g., memory module 159).

In some implementations, a user may upload documents and images or capture photos (e.g., using a camera in communication with a user computing device 102). The AI digital worker 150 may, in some instances, convert these uploads (e.g., converting to JSON format), resulting in structured representations that are linked to an Inquiry ID for later use in downstream tasks. In some instances, redaction rules can be applied to mask sensitive fields before the uploaded documents or images are stored.

The AI digital worker 150 may use various security and permission protocols when ingesting information and/or processing inbound requests to ingest information. In some implementations, all inbound requests are authenticated and authorized before processing. For example, the AI digital worker 150 can enforce system guardrails that constrain how and where types of information can come from. As another example, the AI digital worker 150 can use role templates that prove user/role policies that scope particular actions by role (e.g., supplier, manager, clerk, etc.). The AI digital worker 150 can log each inbound request (e.g., logging inquiry IDs, information sources, and/or other suitable information) and, if the inbound request is denied, why the inbound request was denied (e.g., as a reason code). In some embodiments, the AI digital worker 150 can allow denied inbound request to be elevated and reviewed. For example, an inbound request by one user may be elevated to a user associated with a higher level of access. The user associated with the higher level of access may then review the inbound request and authorize. The memory module 159 can include and/or store the various permissions and/or the AI digital worker 150 may receive them from the user computing device 102 or other devices and information requests are received.

### Scheduler Module 153

According to various embodiments the AI digital worker 150 can include a scheduler module 153 with various job programs. The job programs can include reusable jobs that can be run by the scheduler module 153 to prepare and/or perform common work. The job programs can include a job for email data extraction. The email data extraction job can include a set of instructions for extracting emails. In one embodiment, the email data extraction job can include instructions to first utilize server-side API (e.g., Microsoft Graph) to fetch messages/attachments with a fallback to workstation API or UI automation (e.g., using the RPA module 158) when required. The email data extraction job can include instructions to link various artifacts acquired while extracting data from various emails and messages to an Inquiry ID.

The job programs can include instructions to convert various information into a different format to be used by the system. For example, the job programs can include instructions to convert PDF files to structured JSON files to be used by the AI digital worker 150 in various downstream tasks. The job programs can also include instructions to inspect or check artifacts. For example, the job programs can include instructions to verify or check artifacts and minimal schema. This can help prevent task failure due to insufficiencies in an artifact.

### Builder Module 154

According to embodiments, the AI digital worker 150 can include a builder module 154. The builder module 154 can create tasks and steps for the AI digital worker 150 to perform. In some embodiments, the builder module 154 can cause the user computing device 102 to present a process builder user interface that enables authorized users to create or edit various projects and tasks to be performed by the AI digital worker 150. The process builder user interface can include various structured forms, including per-step execution policies, such as whether a step should use Location Memory or be recalculated by a model each run.

The process builder user interface can include access to project schemas and associated information such as the project name, description, owner, roles/permissions associated with the projects, contacts (e.g., escalation contacts), and/or approvals. The process builder user interface can include displays of each task/step in the project schema. For example, the process builder user interface can include an ordered list of steps with parameters, preconditions, timeouts, retry policies, and various other tools or options (e.g., associated APIs, information from the RPA, databases, or auto selection capabilities). The process builder user interface can include additional information, such as dependencies (e.g., inter-project prerequisites and data dependencies), scheduling (e.g., whether a task is to be immediately performed, deferred, performed recurring, or after a triggering dependency event). The process builder user interface can include artifacts such as linked and/or uploaded files (e.g., JSON artifacts) and/or interface to upload files. The process builder user interface can include various guardrails, such as per-task policy flags (e.g., whitelists of users that can read from or write to various databases).

According to implementation, the process builder interface can include per-step memory strategies. The per-step memory strategies can include controls that govern how the AI digital worker 150 navigates and executes the associated step. The per-step memory strategies can include an option (e.g., a checkbox) to use location memory. When enabled, the option to use location memory can cause the AI digital worker 150 to replay a previously validated navigation/action path for the step without reinvoking additional processes (e.g., without reinvoking an LLM for the step). The option to use location memory can save computational time used for the additional processes (e.g., when executing the additional processes is unlikely to produce a new result).

The per-step memory strategies can also include a selection of various strategies for executing a step. For example, in some embodiments, the per-step memory strategies include the option to select a memory-only option (e.g. a user may select “Memory-only” on the per-step memory strategies), a memory with a fallback process option (e.g. a user may select “Memory-LLM fallback” on the per-step memory strategies), a no-memory process option (e.g. a user may select “LLM-only” on the per-step memory strategies), or a recording process option (e.g. a user may select “LLM-write memory” on the per-step memory strategies). In the memory-only option, the AI digital worker 150 may implement a previously validated navigation/action path for the step without reinvoking additional processes (e.g., without reinvoking an LLM for the step). If the implementation fails, the AI digital worker 150 may log the failure (e.g., for further investigation or escalation). In the memory with a fallback process option, the AI digital worker 150 may first attempt to implement a previously validated navigation/action path for the step without reinvoking additional processes, the same as for the memory-only option. However, in the memory with a fallback process option, if the step fails (or fails more than a predefined number of attempts), the AI digital worker 150 may execute a fallback process (e.g., perform a recalculation, reinvoke an LLM, and/or perform other processes) to perform the step. In the no-memory process option, the AI digital worker 150 may execute a process (e.g., perform a calculation, invoke an LLM, and/or perform other processes) each time the step is performed without using results from a prior execution. In the recording process option, the AI digital worker 150 may execute a process and record the results in memory (e.g., memory module 159) to be used in future executions of the step (e.g., rather than executing the process).

The per-step memory strategies can include various additional/advanced options. For example, the per-step memory strategies can allow a user to set an auto-disable threshold. The auto-disable threshold can identify a number of times the AI digital worker 150 will attempt to perform a step using memory before automatically switching to the no-memory option described above. This switch may remain in effect until a user manually selects an option to use memory for the step. As another example, the per-step memory strategies can allow a user to set a Time to Live (TTL)/staleness policy that defines an amount of time the AI digital worker 150 is to implement a step using memory-only and/or defines changes (e.g., changes in UI signatures of various applications) that will change the memory strategy for the step. As another example, the per-step memory strategies can include options to define a validation profile. The validation profile can include various schema constraints, terms, tests, and/or the like to compare and validate before a process is recorded in memory. As another example, the per-step memory strategies can include an option to enable a user assist mode that permits user-guide GUI correction for the step (e.g., when the step is failed during execution). As another example, the per-step memory strategies can include a write-back toggle that, when enabled, updates locations or mappings in the memory when a process (e.g., an LLM invocation) succeeds for the step.

The process builder interface can include display of telemetry and/or hints related to each step. For example, the UI can show recent success/fail counts by strategy (e.g., Memory vs LLM), average latency, and last validation reason codes to help users pick the right policy for the step. In some implementations, a link can surface the last few screenshots/screenprints (role-gated or permission locked) that were implemented for the step for a user to review.

In some embodiments, the process builder interface can further display telemetry and validation-profile information associated with each process step. The telemetry may include success and failure counts by strategy type (e.g., memory-only, memory with a fallback process option, or no-memory process option), average execution latency, validation reason codes, and recent error trends. A user interface element can provide role-gated access to screenprints or OCR evidence from recent executions to assist with debugging and tuning. The system can generate telemetry hints that suggest configuration changes, such as recommending fallback modes when memory success rates decline below a threshold or when latency increases beyond tolerance levels.

In addition, each process step can reference a reusable validation profile defining schema constraints and canary signatures expected to appear on the user interface before executing a memory-based instruction. The validation profile may specify text terms, layout features, or visual signatures that confirm the correct context and may further include a tolerance rule (e.g., allowable mismatches or skipped fields). If the validation profile fails, the digital worker can suspend the memory replay, perform a model-based verification, or fall back to a recalculated instruction. Validation profiles can be centrally managed, versioned, and assigned to steps, with edits logged under editor identity and timestamp for audit and rollback.

This combination of telemetry and validation profiles can provide human-in-the-loop oversight and explainability of automated execution, allowing administrators to observe behavioral trends, verify UI consistency, and maintain compliance with enterprise governance requirements.

For illustration, a non-limiting example of a data model can be implemented as follows:
memory_strategy (enum: MEMORY_ONLY, MEMORY_THEN_LLM, LLM_ONLY, LLM_THEN_WRITE)
memory_enabled (bool)
auto_disable_threshold (struct: fail_count, window)
memory_ttl_days (int)
validation_profile_id (ref)
assist_allowed (bool)
write_back_on_success (bool)
   Where “memory_strategy” defines a per-step memory strategy, “memory_enabled” defines whether memory can be accessed for the step, “auto_disable_threshold” defines an auto-disable threshold for the step, “memory_ttl_days” defines a TTL/staleness policy for the step, “validation_profile_id” defines a validation profile for the step, “assist_allowed” defines if a user assist is enabled for the step, and “write_back_on_success” defines if a write-back toggle is enabled for the step. All changes to the data model can be logged with an associated editor identity, timestamps, and version differences.

At runtime, the AI digital worker 150 can implement the strategy that has been defined for each step for the task. For example, for each step the AI digital worker 150 can access the memory module 159 and, where permitted, read existing location/mapping stored in the memory module 159 for the step, apply validation before accepting a memory replay, fall back on processes (e.g., invocations to an LLM) per policy (e.g., based on failures to execute the step using memory-only, a mismatch between a current implementation of the step and information stored in the memory, or another triggering condition), read/write successful executions of the step in the memory module 159, and trigger an assist mode when permitted and appropriate. The AI digital worker 150 can log structured events associated with each step (e.g., “Memory disabled for Step 3 due to threshold breach”).

In one embodiment, a step such as “Navigate to Vendor Maintenance page”, a user may choose LLM-only if the UI changes frequently, or Memory-LLM fallback if the path is stable but occasionally shifts after ERP patches. Successful LLM runs can write a refreshed Location/Mapping Memory for subsequent executions.

In various implementations, edits to memory strategy or validation profiles can require appropriate roles. Approvals can be captured and recorded where policy mandates. The AI digital worker 150 can maintain prior versions of step strategies that are available for review and rollback.

### Execution Module 155

In various embodiments, the AI digital worker 150 can include an execution module 155. According to various embodiments, the execution module 155 can include a process execution engine 170 and a step agent 171. Many jobs or tasks may be subject to strict requirements or other criteria. For example, in an accounts receivable context, many jobs must follow generally accepted accounting principles (GAAP). The execution module 155 can receive (e.g., as an artifact or entered manually by a user) the criteria for a job or task and use the criteria in selecting and performing each step for the job.

The process execution engine 170, can define the steps to be performed for a job or task. In some instances, the steps to be performed for a job are manually entered by a user. For example, a user may manually enter each step to be performed to process an invoice. In some instances, the process execution engine 170 may receive or ingest information associated with the criteria. For example, the process execution engine 170 may receive a document or other artifact that defines the criteria. The process execution engine 170 can sequence steps, handle various dependencies, retries, and outcomes based on the criteria. In some embodiments, the process execution engine 170 may generate the step-by-step (e.g., using AI models 162) instructions and present them to a user to confirm or alter. The step agent 171 can then use the step-by-step instructions in performing an instance of a job or task. Accordingly, embodiments of the disclosure maintain a separation between the creation of the step-by-step instructions and the implementation of each step. This can help ensure the criteria associated with a job or task are strictly adhered to and that each step can be controlled and corrected as circumstances dictate.

The step agent 171 can run jobs step-by-step. The AI digital worker 150 can build (e.g., using the builder module 154) instructions to perform each step. The instructions can include, for example, specific tools to use (APIs, RPA module 158, databases, and/or other tools), whether to use memory for the step (e.g., when the step is memory-only with no additional processes or memory-priority with fallback on additional processes, such as invoking an LLM), and whether to record or validate the step using memory.

The step agent 171 can pull the next runnable job (e.g., from a queue set by the AI digital worker 150) and execute the job by performing instructions associated with each step in the job. The step agent 171 can log various states for each job/step, attempts, timestamps, events, and other information which may be displayed to a user (e.g., in a work-in-progress UI). The step agent 171 can apply retry/backoff rules at each step which define rules for re-executing the step. The step agent 171 can mark terminal outcomes (e.g., successful or repeatedly unsuccessful executions) with one or more reason code(s) that identifies information associated with the successful or unsuccessful execution of a step or job.

In some implementations, the execution module 155 will not stall execution of steps for user responses. For example, if a step outcome requires user input (e.g., due to missing data), the execution module 155 can flag the related item as needing user input and move on to a different step or job. Once the flagged item is resolved, the execution module 155 can return to the associated job or task and continue execution. In some implementations, when a user resolves the flagged item (e.g., via a GUI on a user computing device 102) the AI digital worker 150 creates a follow-up job and the execution module 155 re-executes only the affected portion. The execution module 155 may use idempotency keys to prevent duplicate side effects when executing the follow-up jobs.

The execution module 155 can record results for each step (e.g., flag as a success/failure, store artifacts, store metrics, and flag whether memory was used in the step) as a step result. The step results can be stored and/or displayed to a user (e.g., on a work-in-progress user interface).

### Step Execution

For each step, the execution module 155 (e.g., using the step agent 171) can intake a step definition (e.g., parameters, tools, etc.) associated with executing the steps, any linked artifacts (e.g., artifacts or files converted to JSON structures), and policy/permission parameters associated with the step. The tools used to execute a step can be explicitly defined. For example, each step can specify one or more tools used to perform the step (e.g., API agents, the RPA module 158, database agent). In some implementations, there is no runtime toggle between server and workstation operations during execution.

If the step is configured to use memory (e.g., is flagged to use memory-only, or to use memory and fallback on an additional process), the execution module 155 sends the stored JSON instruction (e.g., the previously recorded navigation/element/action) directly to the tool. The execution module 155 then receives an indication of success or failure for the step. If successful, the execution module 155 then moves to the next step. If the step fails, the execution module 155 can troubleshoot the step, proceed to the additional process (if the step is flagged to do so), and/or return a fail status.

If the step is configured to perform a process (e.g., is flagged as process-only or to use an additional process if memory execution fails) the execution module 155 can build instructions for the step using current detection/logic and, where configured, run a screenprint validation to confirm the execution module 155 is on the expected screen/place or perform another instruction validation before sending the instructions to the tool.

The results (e.g., artifacts) of a step can be recorded and used in a future step and validated for future memory-only implementations of the step. If the step is the last step in the job, the job can be marked as complete. Otherwise, the execution module 155 moves on to the next step based on the result (e.g., at a new screen and/or with new information). Each step can return a status (e.g., “success”, “fail” or “needs user action”), tools used (e.g., the API agent, RPA module 158, and/or database agent used), if memory was used to execute the step, if validation was applied, any artifacts or links associated with the step (e.g., screenprints, JSON paths, and/or message IDs), timestamps, number of attempts, and, if failed, a reason code (e.g., “element not found,” “unexpected screen,” “policy blocked”). The status can be stored and displayed to a user (e.g., on a work-in-progress user interface).

### Instruction Validation

The execution module 155 (e.g., using the step agent 171) may perform instruction validation for each step. Instruction validation may typically not be used in steps that are performed using memory, but may at times be used to validate a series of memory steps (e.g., as a boundary validation). To perform the instruction validation, the execution module 155 may perform a screenprint check to validate the expected screen is present before executing a step. In some implementations, instruction validations can include model interpretations (e.g., using an LLM or custom model) to verify the expected screen is present before executing the step.

### Step Troubleshooting

The execution module 155 (e.g., using the step agent 171) can perform various troubleshooting operations (e.g., in response to a failed step or to perform prechecks). If a step is marked to use only memory, the execution module 155 typically sends the stored JSON instruction to the tool associated with the step without further validation. In some instances, such as a non-memory step following a block of memory steps, the execution module 155 can perform a screenprint or other instruction validation before proceeding to the next step.

If a step fails, the execution module 155 can determine a correction path and begin rolling back actions (e.g., closing screens) to return to a stable position. In some instances, the execution module 155 may revert a job to a specific step, erase or refresh associated portions of the memory module 159, and/or log a request of assistance. The execution module 155 may (e.g., using the GUI element detection module 152) re-map various elements associated with the step, flag the step for an assist mode to be performed later, and/or mark the item as needing user assistance. The execution module 155 can record the failure, and if possible, move to additional steps or, if not possible, indicate the job as failed.

In assist mode, the execution module 155 can receive user input providing guidance (e.g., clicking a missing button, add a selector, or confirm the correct field) for execution of the step. In some implementations, assist mode is not launched mid-run of a job and is performed at a later time. The user input guidance is saved as updated mapping in the memory and used in future executions of the step.

### API Agent Module 156, Database Agent Module 157, and RPA Module 158

In various implementations, the AI digital worker 150 can use one or more tools in performing projects or tasks. The AI digital worker 150 may use assigned tools as the AI digital worker 150 proceeds step-by-step through a project or task. According to various embodiments, each step performed by the AI digital worker 150 can have one or more of these tools defined in performing the step. The tools can include an API agent module 156, an RPA module 158, and a database agent module 157.

When a step is configured to be performed using memory (e.g., is defined as a Memory-only step), the AI digital worker 150 can retrieve instructions from the memory module 159 (e.g., stored JSON instructions) associated with the step and provide the instructions to the appropriate tool (e.g., to the RPA module 158). The tool can execute the instructions, which can result in a success or failure to implement the step.

When a step is configured to be performed using additional processes (e.g., the step is flagged as process-only or to use an additional process if memory execution fails), the additional processes, such as invocations to an LLM, can first be performed by the AI digital worker 150 to determine the instructions (e.g., JSON instructions) that are provided to the tools. In some implementations, before instructions that are determined using these additional processes are provided to the tools, the AI digital worker 150 will undergo one or more validation procedures (e.g., screenprint validation) before the instructions are sent to the tool.

### API Agent Module 156

In some embodiments, the tools used by the AI digital worker 150 can include an API agent module 156. The API agent module 156 can execute server-side integrations with messaging, collaboration, and line-of-business systems (e.g., Microsoft Graph for Outlook/Teams; ERP/finance APIs; web services).

The API agent module 156 can take as input instructions, various formats (e.g., JSON instructions) with a structured request. The structured request can include various information used in implementing the step, such as an endpoint (e.g., API endpoints), method, headers, payload, and authorization context. The input request can also include a Step ID and Inquiry ID, tools to be used by the AI digital worker 150, access tokens, task definitions (e.g., instructions for filtering email and finding attachments, data fields to read from, etc.), retry policies, validation schemas, and/or other information associated with the step being performed by the API agent module 156.

The API agent module 156 can implement various guardrails defined in the configuration of the AI digital worker 150 when executing the input instructions. The guardrails can include using configured credential and scopes managed in the configuration of the AI digital worker 150 when sending requests. This can help secure specified information, ensuring the API agent module 156 does not retrieve information a particular user does not have requisite permissions to view. The guardrails can also include scheme checks and policy guardrails (e.g., allowed endpoints/verbs, payload field limits).

In the process of executing a step API agent module 156 may encounter an error (e.g., transient errors), preventing the step from being completed. The API agent module 156 may re-execute the step when some errors occur. The API agent module 156 may also flag the step to be reviewed by a user, flag the step to be placed in a dead-letter list, and/or otherwise handle the error. The API agent module 156 can record response codes, timestamps, and informational IDs associated with the step. In some implementations, the API agent module 156 can, upon completion of a task, return whether the task was a success or failure.

In an example embodiment, the API agent module 156 is used in an accounts payable processes. In this embodiment, the API agent module 156 can, in response to instructions, fetch emails/attachments via an API (e.g., Microsoft Graph or other suitable API) for use by the AI digital worker 150 (e.g., to be used by the builder module 154 to create a job), post status updates or reminder (supplier/approver nudges) via email or messaging, and call ERP/finance APIs for posting, vendor updates, or lookups, when available. However, the API agent module 156 is not limited to these functions and can perform other processes, including others used in accounts payable processes or elsewhere.

### RPA Module 158

In some embodiments, the tools used by the AI digital worker 150 can include an RPA module 158. The RPA module 158 can automate user-interface interactions on one or more dedicated (e.g., allocated) workstation devices, for example, when APIs are unavailable or insufficient for a step (e.g., when the step includes interfacing with desktop applications, legacy forms, or special plug-ins). The RPA module 158 can execute the interactions using UI automation libraries (e.g., keystrokes, mouse input, etc.).

When the RPA module 158 is used in a memory step (e.g., the step is flagged as memory-only), stored instructions (e.g., a JSON instructions) can be provided to the RPA module 158. The instructions can describe UI targets and actions (e.g., mouse clicks, typing, or reading) to be performed on the workstation device. The instructions can also include timing/safety parameters used when executing the step. Accordingly, memory steps can be performed, in some instances, without additional processes (e.g., calls to an LLM) and without validation.

When the RPA module 158 is used in non-memory steps (e.g., the step is flagged to use a process), the RPA module 158 (or other component of the AI digital worker 150) first determines instructions for executing the step. For example, the RPA module 158 can perform a detection and mapping process to determine the instructions. The detection and mapping process can use screenprints, OCR, and GUI-element detection models to identify fields, buttons, or other UI elements used in the performance of the step and generate instructions for the RPA module 158. Prior to executing these generated instructions, the RPA module 158 can perform a validation process. For example, the RPA module 158 can perform a screenprint validation before executing the generated instructions to confirm the expected page, cursor placement, or other UI element is present on the workstation.

The RPA module 158 can perform various operations when a step fails. In some instances, the RPA module 158 can re-attempt to perform the step (e.g., in a regular or “slow” mode). The RPA module 158 (or other component of the AI digital worker 150) can refresh the detection/mapping in the instructions (e.g., by performing the detection and mapping processes described herein). The RPA module 158 can record evidence/reasons of the failure (e.g., capturing screenprints of the relevant UIs), and generate a reason code for the failure. In some instances, the step or associated job can be flagged as needing user action. In these instances, a user may review the step (e.g., in an assist mode) to correct/instruct the process (e.g., correct mappings), which can be saved in the instructions for further runs.

The RPA module 158 can return whether the step was a success or a failure. The RPA module 158 can also log timestamps, action sequences, and selected screenprints. The log can be used to audit the step to ensure correct performance. The log can also include any relevant permissions associated with performance of the step, ensuring sensitive information is protected (e.g., by restricting access to the log to users with the requisite permissions).

### Database Agent Module 157

In some embodiments, the tools used by the AI digital worker 150 can include a database agent module 157. The database agent module 157 can provide controlled access to application data with guardrails (e.g., as defined in the configuration). The database agent module 157 can support both operation reads to databases and policy-approved writes to the database. In an accounts payable implementation, the database agent module 157 may perform, for example, WIP queries and Invoice page searches.

The database agent module 157 can receive instructions with a parameterized query or write request. The instructions can also include relevant Inquiry IDs, role context, and permissions (e.g., whitelist references). The database agent module 157 can enforce relevant permissions in the instructions (or otherwise in the configuration of the AI digital worker 150) such that only permitted tables, views, and stored procedures are used or accessed in a step and/or that only permitted writes are performed in the step.

The database agent module 157 can return and/or store (e.g., in the memory module 159) results and log timestamps, actors, Inquiry IDs, Step IDs, and/or other information associated with the performance of the step. For example, the results can be used in work-in-progress UIs, reporting summary UIs, invoice UIs, and/or elsewhere by the AI digital worker 150. When the database agent module 157 performs a write process to a database, the database agent module 157 can record an actor identity, reason code, a structured diff (where applicable) and/or other information. A user can audit the actions database agent module 157 using the various logs (e.g., by Inquiry ID and Step ID).

In one embodiment, the database agent module 157 can read invoice status, aging, and exception counts (e.g., for use in WIP and invoice pages). In the embodiment, the database agent module 157 writes process flags, such as flagging steps for user action, exception reason codes, and mapping updates (e.g., those created by a user in an assist mode), to one or more databases and/or the memory module 159.

### Memory Module 159

In various embodiments, the AI digital worker 150 includes a memory module 159 which can include various databases, datastores, and/or other suitable computerized information storage. While illustrated as included in the AI digital worker 150, some, or all, of the information described as stored in the memory module 159 may additionally or alternatively be stored externally to the AI digital worker 150 (e.g., on a database 122).

In various implementations, the memory module 159 can include an operational database. The operational database can include stored information used by the AI digital worker 150 in performing various operations. For example, the operational database can include definitions, schedules, parameters, approvals, and/or other information associated with projects, jobs, steps, or other tasks performed by the AI digital worker 150. The operational database can include Inquiry IDs and channel provenance for various intake information (e.g., chat input to the AI digital worker 150, emails, messages, meeting transcripts, and/or other intake information). The operational database can include execution records associated with various projects, jobs, or steps (e.g., starting and ending timestamps, success/failure codes, and various flags, such as flags for user action). The operational database can include aggregate information used in display (e.g., on a work-in-progress or invoice UI). The operational database can include audit logs tracking versions of files and artifacts (e.g., timestamps, tracked changes, authors, and/or other suitable information). The operational database can include configuration and policy information, such as role templates, guardrails, permissions, and/or other information in the configuration of the AI digital worker 150.

Access to the operational database can be managed by the AI digital worker 150 (e.g., by the database agent module 157). For example, the operational database can be read for endpoints in work-in-progress UIs, reporting summaries, and invoice pages. As another example, the AI digital worker 150 can record information, such as task flags, in the operational database.

In various implementations, the memory module 159 can include an instructions document store. The instructions document store can store structured objects (e.g., JSON structures) used by the AI digital worker 150. When information is processed by the AI digital worker 150, the information can be converted into these structured objects that can be reused in multiple operations. For example, PDFs and images can be hashed, deduplicated, converted to JSON (e.g., with indications of field location and page line references of the image or PDF), and stored in the instructions document store with a link to the original file. The conversion to JSON can allow the information to be reused by the AI digital worker 150 without re-parsing the original file each time the information is used. The structured objects can conform to defined schemas so that the output conforms to expected shapes used in various jobs. The structured objects can include referencing information to various artifacts used in the AI digital worker 150 (e.g., by stable IDs/paths). Tasks or steps performed downstream can read the structured objects directly. The instructions document store may include a retention policy (e.g., governed by a tenant policy) for the structured objects and/or redaction rules to mask sensitive fields. In one embodiment, the instructions document store includes invoice JSONs that identify vendors, headers, line items, taxes, totals, PO references, and payment terms.

In various implementations, the memory module 159 can include processing memory. The information in the processing memory can help make frequent UI paths performed by the AI digital worker 150 fast and reliable without invoking a model each run. The processing memory can include location memory, mapping memory, and exception memory. The location memory can store (e.g., as a JSON) a recorded sequence of navigation/actions across screens of one or more applications. The mapping memory can store element-level references, such as instructions on a location of a button or field (e.g., a “send” button) in a UI and/or instructions to navigate a cursor to select the button or field. The exception memory can store known exception classes with preferred next actions. For example, in an accounts payable context, a “request corrected invoice from supplier” may have “escalate to purchasing” as a preferred next action.

At runtime, the AI digital worker 150 may use the processing memory and/or update the processing memory. When a step is flagged to use memory, the AI digital worker 150 can retrieve instructions from the processing memory and provide the instructions to a tool. This can be performed without calls to a model and without validation processes. In some instances, when a block of steps use processing memory, the AI digital worker 150 may perform a validation process (e.g., a screenprint check) to confirm the AI digital worker 150 is on the expected page/place before continuing. If the AI digital worker 150 fails when performing a step using the processing memory, the associated information can be marked with a reason, corrected (e.g., by a user in an assist mode), and updated in the processing memory. The processing memory can have staleness policies (e.g., instructions expire after a defined period of time or after changes in associated applications). Items stored in the memory may include associated timestamps and/or other identifying information that can trigger the item to be deleted or updated according to the staleness policies.

In various implementations, the memory module 159 can include application glossaries. The application glossaries can prove the AI digital worker 150 with relevant words and field names used in the various customer applications 123. The application glossaries can be used so that instructions to the tools and prompts to models are accurate. The application glossaries can include synonyms, field/column names, UI labels, and/or domain phrases (which can include safe examples that can be inserted into job definitions or messages, local terminology or custom fields). During project/job definitions, the AI digital worker 150 can use the application glossaries to label steps and parameters correctly. During process steps (e.g., those performed without processing memory items) the application glossaries can be used to help the AI digital worker 150 assemble workable actions to define instructions to the tools. During communication (e.g., chat messages, UI display, or other communications) the application glossaries can be used to keep language consistent with a user's overall system.

In various implementations, the memory module 159 may store various client specific information. For example, each deployment of the AI digital worker 150 can adapt to client requirements by learning and remembering field mappings, workflow rules, glossary terms, and exception-handling processes. These field mappings, workflow rules, glossary terms, and exception-handling processes can be stored in the memory module 159. In one embodiment, contextual grounding is enhanced with retrieval-augmented glossaries specific to enterprise platforms such as Oracle, SAP, or Lawson. Over time, the AI digital worker 150 can build a contextual memory module 159 unique to each client, enabling seamless customization without explicit reprogramming.

The AI digital worker 150 can utilize the memory module 159 to store navigation and action steps as location memories for rapid reuse without invoking an LLM. In some embodiments, this reduces execution time by replaying prior navigation in seconds rather than recalculating through AI each time. If downstream validation fails, the AI digital worker 150 can invalidate the stored memories and re-execute the workflow and store the updated information from the re-execution in the memory module 159, thereby providing both efficiency and accuracy. This memory-driven replay improves the RPA processes by eliminating or reducing hardcoded paths or recalculating steps at each execution.

In various implementations, the memory module 159 can include security, privacy, and retention information. The security, privacy, and retention information can include tenant isolation (e.g., isolation between different clients) across all information in the memory module 159, role-based access (e.g., sensitive artifacts), encryptions, retention windows for transcripts, artifacts, and cached avatar video, automatic expiry for items not reused within the configured period, and audit information (e.g., all changes to definitions, memories, and policies are versioned with actor and timestamp).

In various implementations, the memory module 159 can include outcome capture and training data. Each execution of a process instance can produce structured outcome data. The outcome data can include the steps attempted, the success or failure of each step, error codes, exception triggers, and user interventions. Screen captures, extracted text, and decision rationale can be stored alongside the execution record for audit and review. The AI digital worker 150 may use the outcome data for visibility into process reliability, exception frequency, and performance. The AI digital worker 150 can generate reports and dashboards to show resolution times, error categories, and intervention rates.

In some instances, the outcome data can form the basis for learning. For example, when a user reviews a failed process and attaches corrective guidance, that data can be linked back to the execution outcome. Over time, this produces a curated knowledge base for each process, enabling deterministic corrections without requiring retraining of machine-learning models.

In various implementations, the memory module 159 can include best-practice guidance information. The best-practice guidance information can include suggestions based on patterns observed by the AI digital worker 150 as jobs are performed. The best-practice guidance information can be anonymized and/or aggregated (e.g., success/failure outcomes and frequently accepted corrections) and can produce suggested steps or checks (e.g., “validate tax treatment before posting”). In some implementations, the best-practice guidance information is presented as a recommendation and may require user (e.g., an authorized user) acceptance before including in further actions taken by the AI digital worker 150.

According to various embodiments, the memory module 159 can store one or more operational parameters that can be used by the AI digital worker 150 in performing various operation. For example, the operational parameters can include glossaries, workflow rules, and exception-handling procedures unique to particular tasks, clients, and/or other circumstances. The operational parameters can include static rules for certain circumstances and/or can include dynamically adapting factors that are updated based on new information, user entered corrections, and/or other factors. For instance, the operational parameters may be updated after the repeat failure of a task and a subsequent user guided correction. Accordingly, the AI digital worker 150 may use the operational parameters to adapt to a variety of circumstances and client specific preferences and to preserve correction to past issues.

### Configuration Module 160

According to embodiments, the AI digital worker 150 can include a configuration module 160 for setting a configuration. The configuration can include, for example, centralized administrative settings, integration credentials, business rules, and execution policies. The configurations can be organization wide, client specific, project specific, and/or otherwise scoped. All changes to the configuration can be versioned and auditable. Changes to the configuration can be marked with timestamps. Further, some, or all, of the information in the configuration may be associated with a required privilege to view and/or change the information (e.g., sensitive items may require a higher security clearance).

In some implementations, the configuration can include integration information with server-side API configurations, environment scoping (e.g., configurations used in development, testing, or production), and privacy/secret management. The configuration can include organization-specific rules (e.g., business rules), such as approval thresholds, exception handling policies, escalation structures and timings, email domain whitelists, and/or other rules. The configuration can include instruction guardrails, such as whitelists/backlists used in reading/writing to and from databases or execution constraints for the RPA (e.g., forbidden windows or applications). The configuration can include role templates, such as per-role permissions that map role-based prompts to action scopes (e.g., actions assigned to a manager may have different action scopes than actions assigned to a clerk).

The configuration can include one or more configuration prompts and/or prompt templates. For example, the configuration can include a template prompt used for invocations to an LLM for various steps of a task. In various embodiments, the configuration can include an instincts prompt that provides system-level guardrail text. The instincts prompt can be managed as a versioned artifact. For example, changes to the instincts prompt can be tracked and versions can be reverted. The configuration can include a toggle policy that provides defaults for client/server execution selection and when dual-run diagnostics are permitted.

### Interface Module 161

The AI digital worker 150 can include an interface module 161 configured to cause one or more GUIs to display on the user computing device 102 and/or in the customer applications 123. These GUIs can include a work-in-progress (WIP) interface, task interfaces, review interfaces, and/or other GUIs described herein.

### Work-In-Progress Interfaces

According to embodiments, the user computing device 102 can present a work-in-progress (WIP) interface that enables authorized users to monitor various projects and tasks performed by the AI digital worker 150. The WIP user interface can include a dashboard overview of the overall workload, aggregate volumes and progress across projects and categories (e.g., invoices retrieved, invoices processed, items in PO/Match exception), with drill-down filtering so users can quickly see what matters to them.

The WIP user interface can include workload totals and stages that provide high-level counters for each major category/stage of a task or project. For example, in one accounts receivable embodiment the WIP user interface may include information indicative of “Total Invoices Retrieved”, “In Progress”, “Completed”, “PO/Match Exceptions”, “Waiting on Supplier”, and “Waiting on Approval”.

The WIP user interface can include information associated with batch progress tracking. For example, when large batches are ingested (e.g., 100 invoices), the WIP user interface can show how many downstream processes/steps have been completed (e.g., “4 processes completed; 96 remaining”), with timestamps for last update.

The WIP user interface can include various selectable filters and views that allow a user to customize which information is displayed. For example, users can choose which categories to display, filter by project, supplier, date range, status, or owning team, and pin preferred views as dashboard tiles.

The WIP user interface can include various summary information. For example, in some embodiments the WIP user interface can include an exception spotlight with tiles (or other user interface features) highlighting backlogs (e.g., “200 invoices in PO/Match exception”), aging distributions, and service level agreement, or other, threshold breaches.

The WIP user interface can include various elements (e.g., tiles or charts) that allow users to navigate to and/or view more specific information. For example, a user may select a tile or chart and open a filtered list of items (e.g., steps in a task) and view detailed information (e.g., links to underlying records, Inquiry IDs, artifacts, uploaded files, version, recent events, or other information). After viewing the specific information, the user can then return to a high-level view (e.g., by making a selection on the WIP user interface).

The WIP user interface can be refreshed automatically. For example, in some instances, the WIP user interface can refresh in real-time (or near real-time) after changes have occurred (e.g., tiles updating from execution events and a queue/scheduler updating after short intervals). In some instances, the WIP user interface may additionally or alternatively be manually updated (e.g., based on user input).

The WIP user interface may be customized based on user permission or role. Some information (e.g., sensitive artifacts) may be restricted from being accessed or viewed without a requisite permission level or specified role associated with a user. For example, certain totals and drill-down information may be hidden or not displayed to users without a requisite position. The permissions may be established using various means (e.g., role IDs, permission IDs, whitelists/blacklists, email domains, and/or other identifying information).

In various implementations, the WIP user interface may include one or more techniques for entering information into the AI digital worker 150. For example, the WIP user interface may include a chat box that allows a user to interface with the AI digital worker 150. The input can include plain language input, such as “How many invoices are in PO/Match exception right now?”, “What percentage of yesterday's batch is complete?”, or “Show me suppliers with the largest backlogs.” The AI digital worker 150 may provide follow-up information to the WIP user interface based on the user input. For instance, the AI digital worker 150 may interface with various databases and models based on the user input and provide relevant feedback information. If the user input is a question, the AI digital worker 150 may provide information (e.g., an answer to the question) to the WIP user interface.

In one embodiment, the WIP user interface includes tiles such as “Invoices Retrieved”, “Invoices Parsed”, “PO/Match Exceptions”, “Waiting on Receiving”, “Approved for Payment”, and “Paid”, each with counts and aging bands. In the embodiment, users can filter the WIP user interface by vendor, company code, or posting period to focus triage.

In various implementations, source information for the WIP user interface (e.g., each tile's metric definition, source tables, filters, and/or other source information) can be versioned. Aspects of the WIP user interface, such as entries in various tables or drill-down lists can include last-updated timestamp, information associated with the generating job or step, and/or other information used for tracking the entries.

In some embodiments, some, or all of the information described with respect to the WIP user interface may be displayed in one or more additional or different graphical user interface. In some embodiments, the user computing device 102 can present a reporting user interface with various information displayed. For example, in one embodiment the reporting user interface can include workload summaries displaying exportable counts by category/stage of a task or project (e.g., for categories, such as: “Invoices Retrieved”, “In Progress”, “Completed”, “PO/Match Exceptions”, and “Waiting on Supplier/Approval”), throughput snapshots displaying basic volume totals by project or task, and one or more input fields to provide input (e.g., questions) to the AI digital worker 150 and display resulting information (e.g., answers to the questions). All the information displayed on the reporting user interface can be associated with role-based permissions which may govern permissions of visibility, access to linked artifacts, or otherwise alter the reporting user interface based on an access level of a user.

### Task Interfaces

According to embodiments, the user computing device 102 can present task interfaces, each associated with a specific project or task. The task interface can allow users to search for and inspect specific tasks or projects and view various information associated with the task (e.g., status, end-to-end processes, and/or other information). In examples where the AI digital worker 150 is used in accounts payable, the task interfaces may display specific invoices and allow users to see their status within the end-to-end process.

The task interfaces can include searches and filters that allow the user to find specific information or filter out information. For example, in an accounts payable implementation, the task interfaces can include searches and filters that allow to search by invoice number, vendor, date range, amount, company code, status (e.g., “Retrieved”, “Parsed”, “Matched”, “PO/Match Exception”, “Waiting on Receiving”, “Approved for Payment”, and “Paid”).

The task interface can include overview information that displays overall information associated with the task or project or sub-tasks/projects therein. For example, in an accounts payable implementation, the task interface can include an invoice overview card that includes current status of the invoice, last update timestamp, owning project/task information, and the next scheduled step (if any).

The task interface can include timeline information associated with a task or project. The timeline information can include timestamps of the various stages of a task or project, result codes associated with output/resulting information of the task or project or steps therein. For example, in an accounts payable implementation, the task interface can include a timeline with step-by-step history for the invoice (e.g., ingesting the invoice, parsing the invoice, matching the invoice, exception/resolution steps for the invoice, approval, and payment) with timestamps and results for each step.

The task interface can include links to various artifacts associated with the task or project. For example, the task interface can include links to source information (e.g., links to conversions, such as PDF to JSON conversions, original files, and/or other source information), related communications (e.g., messages, emails, threads, and/or the like) and any associated identifying information (e.g., Inquiry IDs), and execution evidence (e.g., screenprints or logs from one or more steps of the project or task). The linked information may be subject to role-based (or other) permissions, restricting display or viewing of the information to users with appropriate levels of access, (e.g., based on a whitelist, role, email domain, and/or other suitable determination of access).

The task interface can include one or more fields or tiles that allow a user to input information (e.g., ask questions) to the AI digital worker 150 and receive responses to the information. For example, in an accounts payable implementation, the task interface can include a chat box (or allow a user to otherwise upload text or audio to the AI digital worker 150). In this example, a user can ask and receive answers for invoice-specific questions (e.g., a user typing “What's the status of invoice 12345?” and the AI digital worker 150 displaying the current state of invoice 12345 and a link to the invoice page).

### Review Interfaces

According to various embodiments, when a process instance (e.g., a step) does not execute as intended, the AI digital worker 150 can provide a review interface for the user (e.g., as a GUI to the user computing device 102). The interface can present the sequence of executed steps, the associated screen captures, the extracted text, and the decision rationale used by the AI digital worker 150. The user may select a specific step, mark it as incorrect, and attach a Learning Correction.

The AI digital worker 150 can construct a learning correction consisting of natural-language guidance (e.g., expressed as if training a human accounts payable clerk) together with optional categorical tags. The correction can be stored (e.g., in the memory module 159) within a Process Knowledge Pack (PKP) associated with the process definition. Each PKP can be versioned and may contain procedures, exception playbooks, user-interface mappings, communication templates, and any user-supplied corrections.

The learning corrections can pass through a controlled lifecycle consisting of a draft stage, a shadow stage, an active stage, and a rollback stage. In the shadow stage, the AI digital worker 150 evaluates the correction against live or replayed executions without affecting results. Once validated, the correction is promoted to an active status. If a correction causes repeated failures, it may be automatically quarantined or rolled back.

During subsequent executions of the same process, the AI digital worker 150 can retrieve the PKP and deterministically apply all active learning corrections before invoking any automation tools (e.g., the RPA module 158). Each application of a correction is logged with provenance, including the originating user and evidence artifacts.

The use of learning correction can help continuous improvement without requiring retraining of machine-learning models. Corrections can be isolated to the relevant process, ensuring predictable behavior and auditability, while allowing users to iteratively refine automation in a manner consistent with business practice.

### AI Models 162

According to various embodiments, the AI digital worker 150 can include one or more AI models 162. The AI models 162 can be called to perform one or more options described herein. In various embodiments, the AI models 162 can include various machine-learning models such as language models, large language models (LLM), and/or other suitable machine-learning models. The AI models 162 can aid in various operations of the AI digital worker 150 described herein, including, ingesting information, providing responses, and building step specific instructions. In some embodiments, the AI digital worker 150 does not include any AI models 162 and all AI models used by the AI digital worker 150 are implemented on external sources (e.g., the AI models 121).

### Example Implementations of an AI Digital Worker

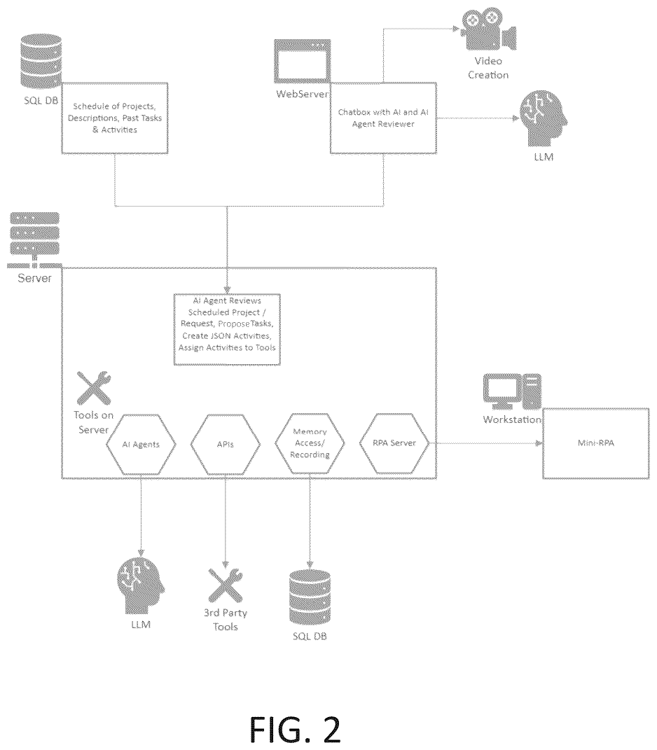

FIG. 2 illustrates an example implementation of an AI digital worker 150. In the example implementation the AI digital worker 150 retrieves a schedule of projects, description, past tasks and activities from a SQL database (e.g., from builder module 154 and/or databases 122) and information from a web server (e.g., a chatbox). Using this, the AI digital worker 150 reviews scheduled projects and requests and creates proposed tasks, JSON activities, and assigns tasks to tools. The proposed tasks can be presented to a user for confirmation. In some embodiments, the AI digital worker 150 may also create certain tasks without user intervention and/or certain tasks can be entirely user created and given to the AI digital worker 150. The illustrated tools include an RPA server (e.g., RPA module 158) to perform actions on a workstation (e.g., on the software applications 104 of the user computing device 102 or the various customer applications 123 of another computing device). The illustrated tools also include memory access/recording on an SQL database (e.g., the database agent module 157 reading from/writing to the memory module 159 or databases 122). The illustrated tools also include API calls to third-party tools (e.g., using the API agent module 156) and instantiations to an LLM (e.g., of the AI models 162 or AI models 121). The AI digital worker 150 can create video (e.g., render an avatar) and/or output text to a user (e.g., via a webserver or other application on the user computing device 102). This process may utilize an LLM (or other of the AI models 162 or AI models 121).

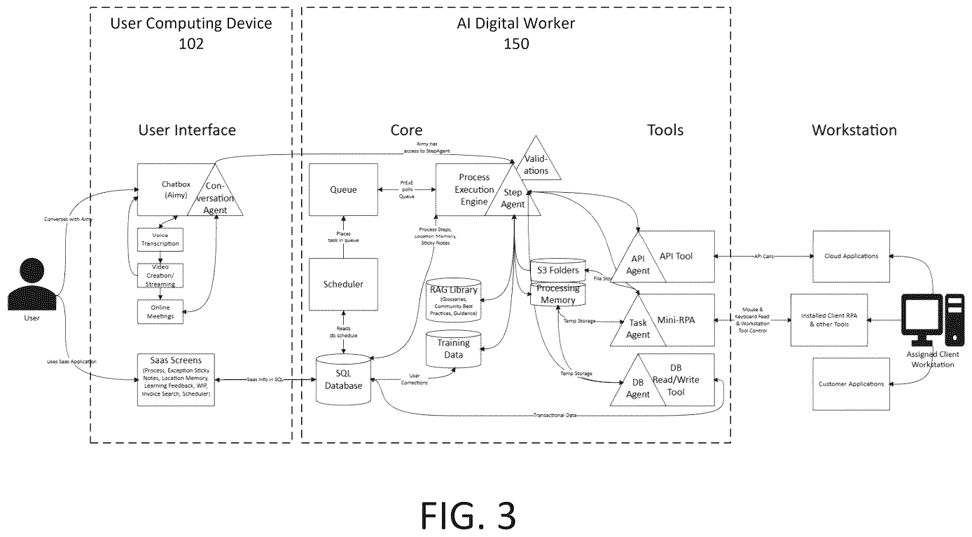

FIG. 3 illustrates another example implementation of an AI digital worker 150. In the illustrated example, a user interacts with the AI digital worker 150 in two ways. First, through plain language conversations via a chatbox or through voice transcription (e.g., from an online meeting). The AI digital worker 150 can provide text or audio feedback to the user via textbox, as a meeting participant, or using other techniques. The second way a user interacts with the AI digital worker 150 is through a SaaS application on the user computing device 102. The user interactions are recorded by the AI digital worker 150 (e.g., in an SQL database and used to create tasks (e.g., either via the scheduler module or builder module) and place the tasks in a queue. If the input includes user correction, the input can also be stored as training data to correct future instantiations of a task or type of task. A step can be claimed from the queue and implemented by the illustrated process execution engine and step agent (e.g., the execution module 153). Based on instructions associated with the task, the step can be assigned a tool (e.g., the API agent module 156, database agent module 157, or RPA module 158). The tools can then execute the task. For example, the API agent module 156 can make an API call to a cloud application in association with a workstation computing device, the mini-RPA module 158 can perform controls (e.g., mouse and keyboard controls) to applications installed on the workstation computing device, and the database agent module 157 can read transaction data stored on the AI digital worker 150. The results of the execution by the tool (e.g., a success or failure) can be recorded on the AI digital worker 150 (e.g., in the memory module 159).

### Example Process for Performing a Task

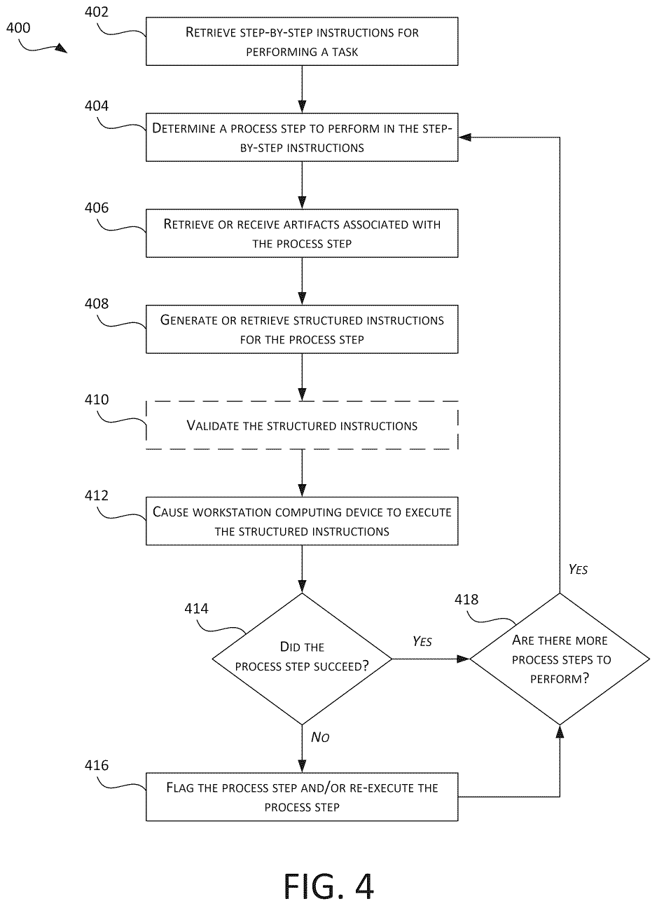

FIG. 4 illustrates a flow diagram of a routine 400 for performing a job or task. The steps of routine 400 are being described as generally being performed by an AI digital worker 150. The functions described in association with FIG. 4 can be performed in a different sequence, can be added, merged, or left out altogether (e.g., not all described acts or events are necessary for the practice of the algorithms). Moreover, in certain embodiments, functions, acts or events can be performed concurrently.

At block 402, the AI digital worker 150 retrieves step-by-step instructions for performing a job or task. According to various implementations, the step-by-step instructions may be user defined (e.g., via a builder module 154) and/or pulled from a scheduled process (e.g., from the scheduler module 153). Further, the job or task may be explicitly user defined (e.g., by directly entering the job or task into the AI digital worker 150 via a user computing device) and/or automatically determined (e.g., derived from various sources, such as a chatbox, virtual meeting, email, and/or other sources discussed herein, using one or more LLMs).

The step-by-step instructions can include process steps or operations within the step-by-step instructions. Examples of process steps can include entering in text to a specific field of a user interface, clicking a particular user interface element, or other operations described herein.

At block 404, the AI digital worker 150 determined the next process step to perform in the step-by-step instructions. The next step may be user defined, from a queue in the AI digital worker 150 and/or otherwise stored on the AI digital worker 150 (e.g., as defined by the process execution engine 170).

At block 406, the AI digital worker 150 retrieves or receives artifacts associated with the process step. The artifacts can include, for example, screenshots of a user interface on a workstation computing device (e.g., the dedicated workstation 125). In some instances, the artifacts include a screenshot of the current view on the workstation computing device user interface. In some instances, the process step may not be associated with any artifacts and the process can proceed directly to block 408 without retrieving or receiving any artifacts.

At block 408, the AI digital worker 150 generates or retrieves structured instructions for the process step. For instance, for some process steps (e.g., those flagged as memory-only) the AI digital worker 150 does not generate the structured instructions and retrieves the structured instructions from memory. In other process steps, the AI digital worker 150 uses a machine learning model (e.g., one or more of the AI models 162) to determine the structured instructions. In some implementations, a machine learning model trained to recognize user interface elements is presented an artifact screenshot of the workstation computing device and instructed to identify user interface elements used to accomplish the process step and/or instructed to generate the structured instructions based on the artifact to accomplish the process step.

At block 410, the AI digital worker 150 may validate the structured instructions. For example, the AI digital worker 150 may compare a current screenshot from the workstation computing device to an expected state of the workstation computing device (e.g., comparing the current screenshot to a screenshot artifact). The AI digital worker 150 can determine if the current state of the workstation computing device sufficiently matches (e.g., as compared to a threshold) what is expected before proceeding. If the state workstation computing device does not sufficiently match, the AI digital worker 150 can flag the process step, regenerate the structured instructions, and/or perform other suitable exceptions operations in response.

At block 412, the AI digital worker 150 causes the workstation computing device to execute the structured instructions. For example, the AI digital worker 150 can cause the workstation computing device to click a user interface element, enter text into a field on the user interface, and/or otherwise operate an application on the workstation computing device.

At block 414, the AI digital worker 150 can determine whether the process step succeeded. For example, the AI digital worker 150 evaluates if the desired effect occurred on the workstation computing device (e.g., by comparing a screenshot to an expected one). If the AI digital worker 150 determines the process step failed, the routine 400 proceeds to block 416. Otherwise, the routine 400 proceeds to block 418.

At block 416, the AI digital worker 150 flags the process step as failing and/or for user review (e.g., flag the process step to later be reviewed in an assist mode). In some instances, the AI digital worker 150 may attempt to re-execute the process step (e.g., reperforming one or more of blocks 406, 408, 410, 412, and/or 414 for the process step). In some instances, the AI digital worker may perform one or more of the various troubleshooting operations described herein to repair or fix the failed process step.

At block 418, the AI digital worker 150 determines whether there are more process steps to perform to accomplish the task. For example, the AI digital worker 150 can utilize various schedulings, rules, schemes, and/or the like in the step-by-step instructions to determine if there are additional process steps to perform in accomplishing the task. If there are more process steps to be performed, the routine 400 returns to block 404 and the AI digital worker 150 determines the next process step and repeats some, or all, of blocks 404, 406, 408, 410, 414, 416, and 418 until the AI digital worker 150 determines there are no more process steps to perform for the task.

### Example Embodiment

In one example implementation, the AI digital worker 150 is used in an accounts payable context. In this implementation, at an invoice parsing or posting stage, a job may execute several memory steps to navigate across various applications, such as Enterprise Resource Planning (ERP) applications, screens. This may be done without additional processes such as calls to an LLM. At the end of this navigation block the AI digital worker 150 (e.g., using the execution module 155) can run a screenprint validation to confirm a “Post Invoice” screen is active and then perform a posting step. If any memory step fails, the AI digital worker 150 marks the invoice as “Needs User Action” (and optionally retries once with fresh detection); later a user can fix mappings via Assist Mode and re-run.

The job can include periodically collecting emails (via API where possible) and dropping them into a common mail bin. Independent processes (e.g., instances of the AI digital worker 150) scan the bin for items that relate to their work (e.g., PO-match exceptions, approvals, internal research). Each process picks up what belongs to it based on IDs/phrases/vendor refs. After all processes have scanned, any remaining emails can be moved to a Human Review folder for manual triage, which can help avoid event-driven stalls and keep processing continuous.

### Additional Examples I

Example 1: A computer-implemented system for executing automated tasks, the system comprising: a process execution engine configured to provide a plurality of process steps defined by a user; a step agent configured to receive the process steps and, for each process step, determine a corresponding robotic process automation action; a memory storing associations between process steps and user-interface elements; and a self-healing mechanism operative when execution of a process step fails, the self-healing mechanism comprising the step agent refreshing the memory to identify an updated association, and persisting the updated association for reuse during subsequent executions of the process.

Example 2: The system of example 1, wherein the step agent determines that a process step has failed by monitoring outcomes of one or more prior steps.

Example 3: The system of example 1, wherein refreshing the memory comprises capturing a screen image of the workstation application and applying optical character recognition to identify candidate user-interface elements.

Example 4: The system of example 1, wherein refreshing the memory comprises detecting graphical user-interface elements in the screen image using a trained model.

Example 5: The system of example 1, wherein refreshing the memory comprises retrieving an alternative stored mapping from the memory.

Example 6: The system of example 1, wherein the updated association is stored together with provenance data including a timestamp, a process identifier, and the execution context in which the update occurred.

Example 7: The system of example 1, wherein the step agent applies the updated association in shadow mode for a plurality of subsequent executions before marking the association as active.

Example 8: The system of example 1, wherein the step agent is configured to toggle execution between client-side and server-side environments based on availability of workstation resources.

Example 9: A computer-implemented system for configuring robotic process automation, the system comprising: a conversational interface configured to receive natural-language instructions from a user; a process execution engine configured to generate a plurality of process steps based on the natural-language instructions; a step agent configured to translate each process step into a robotic process automation action and an associated user-interface target; and a memory storing associations between the natural-language instructions, the generated process steps, and the robotic process automation actions, such that subsequent executions of the process are performed without further user intervention.

Example 10: The system of example 9, wherein the conversational interface comprises a text-based chat interface.

Example 11: The system of example 9, wherein the conversational interface comprises a speech-to-text interface.

Example 12: The system of example 9, wherein the conversational interface comprises an animated digital avatar presenting audio or video output.

Example 13: The system of example 9, wherein the step agent is configured to request clarification from the user when the natural-language instruction is ambiguous.

Example 14: The system of example 9, wherein the memory persists the natural-language instruction together with a corrected robotic process automation action supplied by the user.

Example 15: The system of example 9, wherein the process execution engine associates the plurality of process steps with a process identifier for reuse across subsequent executions.

Example 16: A computer-implemented system for processing accounts payable invoices, the system comprising: a conversational interface configured to receive instructions and queries from a user; an invoice database storing a plurality of invoices, each invoice associated with process data representing a progression of the invoice through a plurality of processing states; a process execution engine configured to execute invoice-related processes based on the processing states, the processes including invoice ingestion, purchase order matching, and exception handling; a step agent configured to translate the processes into robotic process automation actions for execution on a workstation application; and a task agent operative to perform the robotic process automation actions within the workstation application, wherein updates to the processing states in the invoice database determine subsequent processes executed by the process execution engine.

Example 17: The system of example 16, wherein the processing states comprise one or more of: retrieved, completed, purchase-order-matched, or exception.

Example 18: The system of example 16, wherein the process execution engine applies exception playbooks that define remedial actions when a mismatch is detected between an invoice and a purchase order.

Example 19: The system of example 16, wherein the conversational interface generates a notification to a purchasing department requesting a change order when a supplier indicates that a purchase order has been modified.

Example 20: The system of example 16, wherein the conversational interface escalates a transaction to an accounts payable manager when a requested action violates stored business policies.

Example 21: The system of example 16, wherein the invoice database is updated automatically upon completion of each process, thereby preventing subsequent processes from re-executing completed steps.

Example 22: The system of example 16, wherein the task agent executes robotic process automation actions using one or more of: optical character recognition, graphical user-interface element detection, or recorded mappings.

Example 23: A computer-implemented system for process automation, the system comprising: a process execution engine configured to orchestrate a plurality of steps of a user-defined process; a process knowledge pack associated with the user-defined process, the process knowledge pack comprising: stored procedures for executing the process, execution associations linking process steps to the manner in which they are performed in one or more applications, including mappings, rules, or recorded logic, and corrective data supplied by a user in response to a failed execution step; a step agent configured to apply the process knowledge pack during execution of the user-defined process; and wherein the corrective data comprises a natural-language instruction linked to execution artifacts including one or more screen images and decision logic, the corrective data being persisted with the process knowledge pack for reuse in subsequent executions.

Example 24: The system of example 23, wherein the process knowledge pack further comprises exception playbooks defining remedial actions for common error conditions.

Example 25: The system of example 23, wherein the corrective data is reviewed in shadow mode during subsequent executions prior to activation.

Example 26: The system of example 23, wherein the corrective data includes provenance information comprising a user identifier, a timestamp, and the execution context of the failed step.

Example 27: The system of example 23, wherein the process knowledge pack supports versioning such that updated corrections are maintained alongside prior versions.

Example 28: The system of example 23, wherein rollback logic is applied to revert to a prior version of the process knowledge pack if a correction introduces an error.

Example 29: A computing system comprising: at least one processor configured with computer executable instructions, that when executed configure the at least one processor to execute an artificial intelligence-based worker configured to: automate accounts payable processes; manage invoice processing; manage supplier communications; or manage payment exception resolutions.

Example 30: A computer implemented method comprising: executing an artificial intelligence-based worker; and by the AI-based worker, performing at least one of: automating accounts payable processes; managing invoice processing; managing supplier communications; or managing payment exception resolutions.

### Additional Examples II

Example 1: A system for executing automated tasks, the system implementing one or more artificial intelligence models and comprising: a memory; and one or more processors configured to: retrieve, from the memory, information associated with a process step, the information comprising one or more artifacts associated with accomplishing the process step; using one or more machine learning models, generate structured instructions based on the one or more artifacts, the structured instructions comprising computer-executable instructions configured to cause one or more input operations to occur on a workstation computing device; and cause the workstation computing device to execute the structured instructions.

Example 2: The system of example 1, wherein the one or more artifacts comprise a captured screenshot from the workstation computing device, and wherein to generate the structure instructions, the one or more processors are configured to: detect, using the one or more machine learning models, at least one user interface element to interact with in accomplishing the process step;.

Example 3: The system of example 2, wherein at least one of the one or more input operations comprises an interaction with the at least one user interface element.

Example 4: The system of example 1, wherein the one or more processors are further configured to: receive a captured screenshot from the workstation computing device; and verify, using the one or more machine learning models, compatibility of the captured screenshot with the structured instructions.

Example 5: The system of example 1, wherein the one or more processors are further configured to: determine one or more failures occur on the workstation computing device in accomplishing the process step; and cause the workstation computing device to re-execute the structured instructions.

Example 6: The system of example 1, wherein the one or more processors are further configured to: determine one or more failures occur on the workstation computing device in accomplishing the process step; and perform at least one of: flagging the process step for review, or presenting the process step to a user computing device and receiving one or more corrections to the one or more input operations.

Example 7: The system of example 1, wherein the one or more processors are further configured to store the generated structured instructions in the information associated with the process step.

Example 8: The system of example 7, wherein the one or more processors are further configured to: after executing the computer-executable instructions, retrieve the information associated with the process step from the memory; and cause the workstation computing device to execute the structured instructions stored in the information associated with the process step.

Example 9: The system of example 1, wherein the one or more processors are further configured to: retrieve, from the memory, information associated with a second process step, the information comprising a second one or more artifacts, the second one or more artifacts associated with accomplishing the second process step; using the one or more machine learning models, generate second structured instructions based on the second one or more artifacts, the second structured instructions comprising second computer-executable instructions configured to cause a second one or more input operations to occur on the workstation computing device; and cause the workstation computing device to execute the second structured instructions.

Example 10: The system of example 1, wherein the one or more input operations comprises a mouse or keyboard input on the workstation computing device.

Example 11: A system for executing automated tasks, the system implementing one or more artificial intelligence models and comprising: a memory; and one or more processors configured to: retrieve, from the memory, step-by-step instructions for performing a task, the step-by-step instructions comprising one or more process steps in the task; and for each of the one or more process steps: retrieve one or more artifacts associated with accomplishing the process step; using one or more machine learning models, generate structured instructions based on the one or more artifacts, the structured instructions comprising computer-executable instructions configured to cause one or more input operations to occur on a workstation computing device; and cause the workstation computing device to execute the structured instructions.

Example 12: The system of example 11, wherein the one or more processors are further configured to: receive, from a user computing device, a per step strategy for each of the one or more processes steps; and for each of the one or more process steps, generate the structured instructions based on the per step strategy associated with a current process step.

Example 13: The system of example 11, wherein the step-by-step instructions include one or more operational parameters configured to provide the one or more machine learning models context associated the performance of the task.

Example 14: The system of example 13, wherein the operational parameters comprise at least one of glossary to use to perform the task, workflow rules, or exception handling procedures.

Example 15: The system of example 11, wherein the one or more processors are further configured to: present, on a user interface, at least one of: the one or more process steps in the task; the one or more artifacts associated with accomplishing one of the one or more process steps; or the one or more input operations associated with one of the one or more process steps; receive, via the user interface, one or more user inputs providing feedback; and updating the one or more process steps.

Example 16: A computer-implemented method for executing automated tasks using one or more artificial intelligence models, the method comprising: retrieving, from a memory, information associated with a process step, the information comprising one or more artifacts associated with accomplishing the process step; using one or more machine learning models, generating structured instructions based on the one or more artifacts, the structured instructions comprising computer-executable instructions configured to cause one or more input operations to occur on a workstation computing device; and causing the workstation computing device to execute the structured instructions.

Example 17: The method of example 17, wherein the one or more artifacts comprise a captured screenshot from the workstation computing device, and wherein generating the structure instructions comprises: detect, using the one or more machine learning models, at least one user interface element to interact with in accomplishing the process step;.

Example 18: The method of example 18, wherein at least one of the one or more input operations comprises an interaction with the at least one user interface element.

Example 19: The method of example 17, further comprising: receiving a captured screenshot from the workstation computing device; and verifying, using the one or more machine learning models, compatibility of the captured screenshot with the structured instructions.

Example 20: The method of example 17, further comprising: determining one or more failures occur on the workstation computing device in accomplishing the process step; and causing the workstation computing device to re-execute the structured instructions.

Example 21: The method of example 17, further comprising: determining one or more failures occur on the workstation computing device in accomplishing the process step; and at least one of: flagging the process step for review, or presenting the process step to a user computing device and receiving one or more corrections to the one or more input operations.

Example 22: The method of example 17, further comprising storing the generated structured instructions in the information associated with the process step.

Example 23: The method of example 22, further comprising: after executing the computer-executable instructions, retrieving the information associated with the process step from the memory; and causing the workstation computing device to execute the structured instructions stored in the information associated with the process step.

Example 24: The method of example 17, further comprising: retrieving, from the memory, information associated with a second process step, the information comprising a second one or more artifacts, the second one or more artifacts associated with accomplishing the second process step; using the one or more machine learning models, generating second structured instructions based on the second one or more artifacts, the second structured instructions comprising second computer-executable instructions configured to cause a second one or more input operations to occur on the workstation computing device; and causing the workstation computing device to execute the second structured instructions.

Example 25: The method of example 17, wherein the one or more input operations comprises a mouse or keyboard input on the workstation computing device.

Example 26: A system for executing automated tasks, the system implementing one or more artificial intelligence models and comprising: a memory; and one or more processors configured to: retrieve, from the memory, step-by-step instructions for performing a task, the step-by-step instructions comprising one or more process steps in the task; and for each of the one or more process steps: retrieve one or more artifacts associated with accomplishing the process step; using one or more machine learning models, generate structured instructions based on the one or more artifacts, the structured instructions comprising computer-executable instructions configured to cause one or more input operations to occur on a workstation computing device; and cause the workstation computing device to execute the structured instructions; wherein the one or more processors are further configured to associate each of the one or more process steps with a validation profile defining one or more of schema constraints, visual signatures, or elements expected to appear in a user interface before causing the workstation computing device to execute the structured instructions.

Example 27: The system of example 26, wherein the one or more processors apply telemetry to record one or more of: success and failure rates, latency, or validation outcomes.

Example 28: The system of example 27, wherein the one or more processors are configured to, based on the telemetry, dynamically update at least one of: the one or more process steps, the one or more artifacts associated with a process step, or the structured instruction associated with a process step.

Example 29: The system of example 26, wherein the one or more processors are further configured to: on a failure of a process step, record details of the failure and flag the process step for review.

Example 30: The system of example 29, wherein the one or more processors are further configured to detect a user session or availability, present an indication of the flagged process step, and present a user interface to a user.

Example 31: The system of example 30, wherein the user interface comprises a guided dialogue configured to receive user input to obtain correction or approvals, and wherein one or more processors are configured to update at least one of: the one or more process steps, the one or more artifacts associated with a process step, or the structured instruction associated with a process step based on the user input.

Example 32: The system of example 30, wherein the user interface comprises a graphical user interface displaying a representation of a relevant screen or element associated with the fail step and configured to receive user input to obtain correction or approvals, and wherein one or more processors are configured to update at least one of: the one or more process steps, the one or more artifacts associated with a process step, or the structured instruction associated with a process step based on the user input.

Example 33: The system of example 26, wherein the one or more processors are further configured to store at least one of exception events, corresponding communications, and user resolutions.

Example 34: The system of example 33, wherein the one or more processors are configured to apply a learning model to analyze one or more of the exception events, corresponding communications, and user resolutions and apply corrective actions during future executions of similar process steps.

Example 35: A system implementing one or more artificial intelligence models and comprising one or more processors configured to: interface with a live audio or video meeting, wherein interfacing comprises at least one of: providing synthesized audio and video output to the live audio or video meeting, receiving live speech or closed-caption text as input, and/or extraction information or action items based on the live audio or video meeting.

Example 36: The system of example 36, wherein the synthesized video is presented in the live meeting as a digital avatar visible to other meeting attendees.

### Example Computing Device

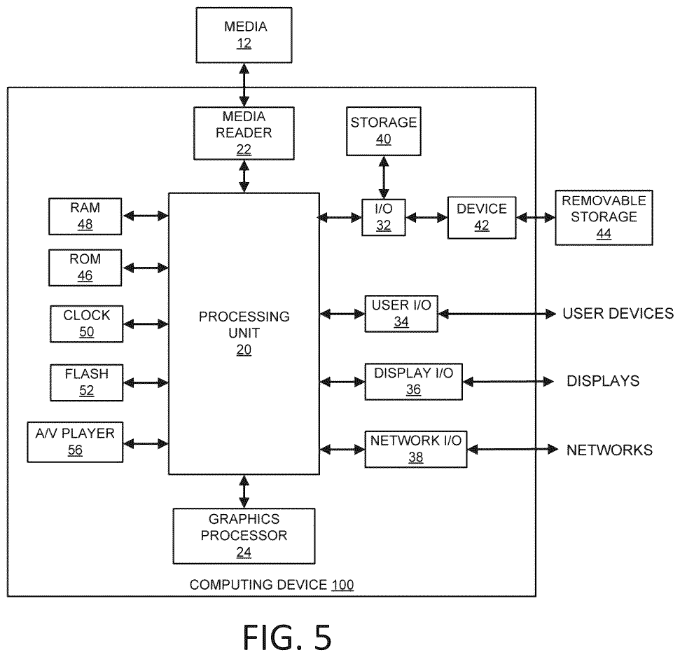

The FIG. 5 illustrates an embodiment of computing device 100 (e.g., the user computing device 102 or other computing device) according to the present disclosure. Other variations of the computing device 100 may be substituted for the examples explicitly presented herein, such as removing or adding components to the computing device 100. The computing device 100 may include a game device, a smart phone, a tablet, a personal computer, a laptop, a smart television, a car console display, a server, and the like. As shown, the computing device 100 includes a processing unit 20 that interacts with other components of the computing device 100 and also external components to computing device 100. A media reader 22 is included that communicates with media 12. The media reader 22 may be an optical disc reader capable of reading optical discs, such as CD-ROM or DVDs, or any other type of reader that can receive and read data from game media 12. One or more of the computing devices may be used to implement one or more of the systems disclosed herein.

Computing device 100 may include a separate graphics processor 24. In some cases, the graphics processor 24 may be built into the processing unit 20. In some such cases, the graphics processor 24 may share Random Access Memory (RAM) with the processing unit 20. Alternatively, or in addition, the computing device 100 may include a discrete graphics processor 24 that is separate from the processing unit 20. In some such cases, the graphics processor 24 may have separate RAM from the processing unit 20. Computing device 100 might be a handheld video game device, a dedicated game console computing system, a general-purpose laptop or desktop computer, a smart phone, a tablet, a car console, or other suitable system.

Computing device 100 also includes various components for enabling input/output, such as an I/O 32, a user I/O 34, a display I/O 36, and a network I/O 38. I/O 32 interacts with storage element 40 and, through a device 42, removable storage media 44 in order to provide storage for computing device 100. Processing unit 20 can communicate through I/O 32 to store data, such as game state data and any shared data files. In addition to storage 40 and removable storage media 44, computing device 100 is also shown including ROM (Read-Only Memory) 46 and RAM 48. RAM 48 may be used for data that is accessed frequently, such as when a game is being played or the fraud detection is performed.

User I/O 34 is used to send and receive commands between processing unit 20 and user devices, such as game controllers. In some embodiments, the user I/O can include a touchscreen inputs. The touchscreen can be capacitive touchscreen, a resistive touchscreen, or other type of touchscreen technology that is configured to receive user input through tactile inputs from the user. Display I/O 36 provides input/output functions that are used to display images from the game being played. Network I/O 38 is used for input/output functions for a network. Network I/O 38 may be used during execution of a game, such as when a game is being played online or being accessed online and/or application of fraud detection, and/or generation of a fraud detection model.

Display output signals produced by display I/O 36 comprising signals for displaying visual content produced by computing device 100 on a display device, such as graphics, user interfaces, video, and/or other visual content. Computing device 100 may comprise one or more integrated displays configured to receive display output signals produced by display I/O 36. According to some embodiments, display output signals produced by display I/O 36 may also be output to one or more display devices external to computing device 100, such as a display 16.

The computing device 100 can also include other features that may be used with a game, such as a clock 50, flash memory 52, and other components. An audio/video player 56 might also be used to play a video sequence, such as a movie. It should be understood that other components may be provided in computing device 100 and that a person skilled in the art will appreciate other variations of computing device 100.

Program code can be stored in ROM 46, RAM 48 or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as game media 12 (which can be a CD-ROM, cartridge, memory chip or the like, or obtained over a network or other electronic channel as needed). In general, program code can be found embodied in a tangible non-transitory signal-bearing medium.

Random access memory (RAM) 48 (and possibly other storage) is usable to store variables and other game and processor data as needed. RAM is used and holds data that is generated during the execution of an application, and portions thereof might also be reserved for frame buffers, application state information, and/or other data needed or usable for interpreting user input and generating display outputs. Generally, RAM 48 is volatile storage and data stored within RAM 48 may be lost when the computing device 100 is turned off or loses power.

As computing device 100 reads media 12 and provides an application, information may be read from game media 12 and stored in a memory device, such as RAM 48. Additionally, data from storage 40, ROM 46, servers accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. A system for executing automated tasks, the system implementing one or more artificial intelligence models and comprising:
a memory; and
one or more processors configured to:
retrieve, from the memory, information associated with a process step, the information comprising one or more artifacts associated with accomplishing the process step;
using one or more machine learning models, generate structured instructions based on the one or more artifacts, the structured instructions comprising computer-executable instructions configured to cause one or more input operations to occur on a workstation computing device; and
cause the workstation computing device to execute the structured instructions.

2. The system of claim 1, wherein the one or more artifacts comprise a captured screenshot from the workstation computing device, and wherein to generate the structure instructions, the one or more processors are configured to:
detect, using the one or more machine learning models, at least one user interface element to interact with in accomplishing the process step;.

3. The system of claim 2, wherein at least one of the one or more input operations comprises an interaction with the at least one user interface element.

4. The system of claim 1, wherein the one or more processors are further configured to:
receive a captured screenshot from the workstation computing device; and
verify, using the one or more machine learning models, compatibility of the captured screenshot with the structured instructions.

5. The system of claim 1, wherein the one or more processors are further configured to:
determine one or more failures occur on the workstation computing device in accomplishing the process step; and
cause the workstation computing device to re-execute the structured instructions.

6. The system of claim 1, wherein the one or more processors are further configured to:
determine one or more failures occur on the workstation computing device in accomplishing the process step; and
perform at least one of:
flagging the process step for review, or
presenting the process step to a user computing device and receiving one or more corrections to the one or more input operations.

7. The system of claim 1, wherein the one or more processors are further configured to store the generated structured instructions in the information associated with the process step.

8. The system of claim 7, wherein the one or more processors are further configured to:
after executing the computer-executable instructions, retrieve the information associated with the process step from the memory; and
cause the workstation computing device to execute the structured instructions stored in the information associated with the process step.

9. The system of claim 1, wherein the one or more processors are further configured to:
retrieve, from the memory, information associated with a second process step, the information comprising a second one or more artifacts, the second one or more artifacts associated with accomplishing the second process step;
using the one or more machine learning models, generate second structured instructions based on the second one or more artifacts, the second structured instructions comprising second computer-executable instructions configured to cause a second one or more input operations to occur on the workstation computing device; and
cause the workstation computing device to execute the second structured instructions.

10. The system of claim 1, wherein the one or more input operations comprises a mouse or keyboard input on the workstation computing device.

11. A system for executing automated tasks, the system implementing one or more artificial intelligence models and comprising:
a memory; and
one or more processors configured to:
retrieve, from the memory, step-by-step instructions for performing a task, the step-by-step instructions comprising one or more process steps in the task; and
for each of the one or more process steps:
retrieve one or more artifacts associated with accomplishing the process step;
using one or more machine learning models, generate structured instructions based on the one or more artifacts, the structured instructions comprising computer-executable instructions configured to cause one or more input operations to occur on a workstation computing device; and
cause the workstation computing device to execute the structured instructions.

12. The system of claim 11, wherein the one or more processors are further configured to:
receive, from a user computing device, a per step strategy for each of the one or more processes steps; and
for each of the one or more process steps, generate the structured instructions based on the per step strategy associated with a current process step.

13. The system of claim 11, wherein the step-by-step instructions include one or more operational parameters configured to provide the one or more machine learning models context associated the performance of the task.

14. The system of claim 13, wherein the operational parameters comprise at least one of glossary to use to perform the task, workflow rules, or exception handling procedures.

15. The system of claim 11, wherein the one or more processors are further configured to:
present, on a user interface, at least one of:
the one or more process steps in the task;
the one or more artifacts associated with accomplishing one of the one or more process steps; or
the one or more input operations associated with one of the one or more process steps;
receive, via the user interface, one or more user inputs providing feedback; and
updating the one or more process steps.

16. A computer-implemented method for executing automated tasks using one or more artificial intelligence models, the method comprising:
retrieving, from a memory, information associated with a process step, the information comprising one or more artifacts associated with accomplishing the process step;
using one or more machine learning models, generating structured instructions based on the one or more artifacts, the structured instructions comprising computer-executable instructions configured to cause one or more input operations to occur on a workstation computing device; and
causing the workstation computing device to execute the structured instructions.

17. The method of claim 17, wherein the one or more artifacts comprise a captured screenshot from the workstation computing device, and wherein generating the structure instructions comprises:
detect, using the one or more machine learning models, at least one user interface element to interact with in accomplishing the process step.

18. The method of claim 18, wherein at least one of the one or more input operations comprises an interaction with the at least one user interface element.

19. The method of claim 17, further comprising:
receiving a captured screenshot from the workstation computing device; and
verifying, using the one or more machine learning models, compatibility of the captured screenshot with the structured instructions.

20. The method of claim 17, further comprising:
determining one or more failures occur on the workstation computing device in accomplishing the process step; and
causing the workstation computing device to re-execute the structured instructions.

21. The method of claim 17, further comprising:
determining one or more failures occur on the workstation computing device in accomplishing the process step; and
at least one of:
flagging the process step for review, or
presenting the process step to a user computing device and receiving one or more corrections to the one or more input operations.

22. The method of claim 17, further comprising storing the generated structured instructions in the information associated with the process step.

23. The method of claim 22, further comprising:
after executing the computer-executable instructions, retrieving the information associated with the process step from the memory; and
causing the workstation computing device to execute the structured instructions stored in the information associated with the process step.

24. The method of claim 17, further comprising:
retrieving, from the memory, information associated with a second process step, the information comprising a second one or more artifacts, the second one or more artifacts associated with accomplishing the second process step;
using the one or more machine learning models, generating second structured instructions based on the second one or more artifacts, the second structured instructions comprising second computer-executable instructions configured to cause a second one or more input operations to occur on the workstation computing device; and
causing the workstation computing device to execute the second structured instructions.

25. The method of claim 17, wherein the one or more input operations comprises a mouse or keyboard input on the workstation computing device.
